(19) United States
(12) Patent Application Publication
(10) Pub. No.: US 2026/0313087 A1
(43) Pub. Date: Oct. 8, 2026

(54) Autostereoscopic Display System

(71) Applicant: JoyVision Technology.,CO LTD, Taoyuan City (TW)

(72) Inventors: Cheng-Chung Hu, Taoyuan City (TW); Hsiu-Hung Lin, New Taipei City (TW)

(21) Appl. No.: 19/717,794

(22) Filed: Jun. 24, 2026

Related U.S. Application Data
(63) Continuation-in-part of application No. 19/453,099, filed on Jan. 20, 2026.
Application No. 19/453,099 is a continuation-in-part of application No. 19/214,113, filed on May 21, 2025, now Pat. No. 12,713,000.

(30) Foreign Application Priority Data
Jan. 23, 2025 (TW) 114103146
Aug. 19, 2025 (TW) 114131639

(51) Int. Cl. H04N 13/398; G02B 30/28; G02F 1/1337; G02F 1/1343; H04N 13/32; H04N 13/385

(52) U.S. Cl. CPC H04N 13/398; G02B 30/28; G02F 1/133723; G02F 1/134363; H04N 13/32; H04N 13/385

(57) ABSTRACT

An autostereoscopic display system includes a display device, a liquid crystal lens, and a control circuit. The liquid crystal lens includes a liquid crystal layer and laterally offset first and second electrode groups. The control circuit alternately displays left-eye and right-eye image segments according to first and second pixel assignments in different periods, and correspondingly drives the first and second electrode groups to switch the liquid crystal lens between first and second lens states. The second lens state laterally displaces an optical action region of the liquid crystal lens by an amount corresponding to a positional difference between the first and second pixel assignments.

### CROSS-REFERENCE TO RELATED APPLICATIONS

This application is a continuation-in-part of U.S. patent application Ser. No. 19/453,099, filed on Jan. 20, 2026, the disclosure of which is incorporated herein by reference in its entirety.

### PRIOR ART

In order to enable a viewer to perceive three-dimensional (3D) depth without the need to wear special eyewear, various autostereoscopic display technologies have been proposed. Conventional approaches primarily employ lenticular lenses. In one commonly adopted implementation, a lenticular lens array is disposed in front of a display panel so as to direct different groups of pixels toward a viewer's left eye and right eye, respectively. Such techniques are described, for example, in U.S. Pat. No. 4,959,641, which discloses a stereoscopic display system capable of providing parallax images, thereby allowing a viewer to perceive 3D visual depth without wearing stereoscopic glasses. However, display devices based on lenticular lenses suffer from several drawbacks, including limited viewing angles, reduced image resolution, and color distortion. By contrast, liquid-crystal lens technologies—such as those disclosed in Chinese Patent Grant Publication No. CN104597685B—provide an alternative solution, in which image separation may be achieved by controlling optical characteristics of a liquid-crystal layer.

As shown in FIG. 1B, when a two-dimensional pixel array is operated in a two-dimensional display mode, the pixel array may use substantially all display pixels to display a two-dimensional image. For example, the pixel array shown in FIG. 1B includes twelve columns and four rows of display pixels 5, and therefore may provide a display resolution corresponding to 12×4, namely forty-eight display pixels 5, in the two-dimensional display mode. By contrast, as shown in FIG. 2B, when the pixel array is operated in a three-dimensional display mode, the display pixels 5 are allocated to different pixel groups for presenting different view images. For example, a portion of the display pixels 5 may be assigned to a left-eye pixel group, such as a pixel group l1, and another portion of the display pixels 5 may be assigned to a right-eye pixel group, such as a pixel group r1. The left-eye pixel group and the right-eye pixel group are optically directed toward a left eye and a right eye of a viewer, respectively, by an optical element such as a liquid crystal lens.

Accordingly, in the three-dimensional display mode, the forty-eight display pixels 5 of the pixel array are divided between the left-eye image and the right-eye image. When the display pixels 5 are substantially evenly allocated to the left-eye pixel group and the right-eye pixel group, each eye receives image information from only about one half of the display pixels that would otherwise be available in the two-dimensional display mode. As a result, a conventional three-dimensional display operation may reduce the effective per-eye resolution relative to the two-dimensional display mode.

### BACKGROUND OF THE INVENTION

The present invention relates to an autostereoscopic display, and more particularly to an improved liquid-crystal lens configured to enhance autostereoscopic display performance.

### SUMMARY OF THE INVENTION

In view of the foregoing, embodiments of the present disclosure provide an autostereoscopic display system in which a display pixel assignment and a lens state of a liquid crystal lens are coordinated over multiple periods. By changing which display pixels are used to display left-eye image information and right-eye image information in different periods, and by correspondingly shifting an optical action region of the liquid crystal lens, the system may allow each eye of a viewer to receive image information from different display pixels while maintaining proper separation between the left-eye image and the right-eye image.

In some embodiments, an autostereoscopic display system includes a display device, a liquid crystal lens, and a control circuit. The display device is configured to display image content including a left-eye image and a right-eye image, and includes a plurality of display pixels. The liquid crystal lens is disposed on one side of the display device and includes a liquid crystal layer, a first electrode group, and a second electrode group. The first electrode group and the second electrode group are laterally offset from each other. By switching between driving states of the first electrode group and the second electrode group, an effective electric-field distribution in the liquid crystal layer may be changed, thereby laterally displacing an optical action region of the liquid crystal lens.

In some embodiments, the control circuit is coupled to the display device and the liquid crystal lens. The control circuit may control the display device to generate the left-eye image and the right-eye image, provide at least a first left-eye image segment and a second left-eye image segment from the left-eye image, and provide at least a first right-eye image segment and a second right-eye image segment from the right-eye image. During a plurality of first periods, the control circuit may control the display device to display the first left-eye image segment and the first right-eye image segment according to a first pixel assignment, and may drive the first electrode group to operate the liquid crystal lens in a first lens state. In the first lens state, the first left-eye image segment is directed toward a left eye of a viewer, and the first right-eye image segment is directed toward a right eye of the viewer.

During a plurality of second periods alternating with the plurality of first periods, the control circuit may control the display device to display the second left-eye image segment and the second right-eye image segment according to a second pixel assignment, and may drive the second electrode group to operate the liquid crystal lens in a second lens state. The second left-eye image segment and the second right-eye image segment may be displayed at different pixel positions in a lateral direction relative to the first pixel assignment. The second lens state may laterally displace the optical action region of the liquid crystal lens, relative to the first lens state, by an amount corresponding to a positional difference between the first pixel assignment and the second pixel assignment, such that the second left-eye image segment is directed toward the left eye of the viewer and the second right-eye image segment is directed toward the right eye of the viewer.

Embodiments of the present disclosure use electrical potential control of a liquid crystal lens to laterally displace an optical action region, thereby optically directing image light toward a corresponding eye of a viewer. This differs from a shutter-based attenuation mechanism in which variable-transparency shutter components selectively attenuate undesired light.

By alternately performing the first pixel assignment and the second pixel assignment, the control circuit may cause the left eye of the viewer to view the first left-eye image segment and the second left-eye image segment in different periods, and may cause the right eye of the viewer to view the first right-eye image segment and the second right-eye image segment in different periods. Accordingly, the system may increase the amount of spatial image information delivered to each eye over multiple periods, while maintaining autostereoscopic separation of the left-eye image and the right-eye image.

In some embodiments, the amount by which the optical action region is laterally displaced need not be equal to a physical pixel pitch. The amount may correspond to a pixel pitch, a sub-pixel pitch, a fraction of a pixel pitch, a pitch between pixel groups, or an optically equivalent lateral offset determined according to one or more optical or display parameters. Such parameters may include a pixel pitch of the display device, a lateral offset between the first electrode group and the second electrode group, an electrode pitch, a liquid crystal cell gap, a refractive-index distribution of the liquid crystal lens, a viewing distance, or a target viewing zone.

In some embodiments, the foregoing pixel-assignment control and lens-state switching may be implemented together with a liquid-crystal lens structure configured to improve optical efficiency and stereoscopic image quality. For example, the liquid-crystal lens may be disposed above a pixel array arranged along a row direction and a column direction. The liquid-crystal lens may include a plurality of elongated lens units extending parallel to one another and having a lens direction extending across the row direction.

Under optical operation, each lens unit may be configured to form multiple pixel groups and to define boundaries between adjacent pixel groups, thereby producing a multi-view separation effect for stereoscopic image generation. In some embodiments, a polyimide (PI) alignment layer may be provided within the liquid-crystal lens structure, and an alignment direction of the PI alignment layer may be formed by rubbing so as to be substantially perpendicular to the lens direction. This rubbed alignment orientation enables liquid-crystal molecules within the liquid-crystal lens to assume a stable and uniform alignment, thereby defining an effective optical axis of the liquid-crystal lens under an applied electric field.

Accordingly, when incident light enters the liquid-crystal lens with a polarization direction substantially parallel to the alignment direction of the liquid-crystal molecules, optical efficiency may be improved and polarization-induced optical loss may be reduced. To achieve such polarization matching, a half-wave plate may be disposed between the display device and the liquid-crystal lens structure. The half-wave plate may be configured to rotate a polarization direction of incident linearly polarized light such that the rotated polarization direction is aligned with the alignment direction of the alignment layer of the liquid-crystal lens. In some embodiments, the alignment direction of the alignment layer is substantially perpendicular to the lens direction of the liquid-crystal lens. Accordingly, incident light may enter the liquid-crystal lens along a polarization orientation corresponding to an optical axis of the liquid-crystal lens.

By virtue of the foregoing polarization-control mechanism, the liquid-crystal lens may modulate incident light in an efficient manner, while reducing optical crosstalk, luminance degradation, contrast reduction, or other adverse effects caused by polarization mismatch. By calibrating the polarization direction of the incident light to be substantially parallel to the alignment direction of the polyimide alignment layer, and by arranging the alignment direction to be substantially perpendicular to the lens direction, the liquid-crystal lens may operate under improved polarization conditions, thereby improving stereoscopic image quality. These and other features and advantages of the present disclosure will become apparent from the following detailed description and accompanying drawings.

### BRIEF DESCRIPTION OF DRAWINGS

FIGS. 1A-1B illustrate a display system in which display pixels are arranged in rows and columns, and optical elements are disposed to overlie the display pixels.

FIGS. 2A-2B illustrate a display system configured to direct different images toward a viewer's left eye and right eye, respectively, and schematically show how different pixel groups are guided by optical elements to achieve a stereoscopic display effect.

FIGS. 3A-3B illustrate an embodiment of a display device including a liquid-crystal lens structure comprising lens units formed of liquid-crystal material.

FIG. 4 illustrates an embodiment in which a half-wave plate is disposed above a twisted-nematic (TN) structure or a similar configuration, in which liquid-crystal molecules rotate a polarization direction of light passing therethrough.

FIG. 5 illustrates another embodiment of a display device.

FIGS. 6A and 6B illustrate an embodiment including a third alignment layer having a predetermined alignment direction substantially perpendicular to a lens direction.

FIGS. 7A and 7B illustrate an embodiment in which a third polarizer is incorporated to ensure a consistent polarization direction of light entering a liquid-crystal lens.

FIGS. 8A through 8D illustrate an embodiment in which a half-wave plate is configured to rotate a polarization direction of transmitted light.

FIGS. 9A and 9B illustrate an embodiment in which the image segments corresponding to the right-eye image field and the left-eye image field are reassigned to different pixel groups in coordination with a switching of electrode configurations of a liquid-crystal lens.

FIGS. 10A through 10H illustrate an embodiment of a stereoscopic display system employing a liquid-crystal lens, in which an effective electric-field position of the liquid-crystal lens is laterally shifted by selectively driving at least two sets of electrodes, and in which different electrode-pattern shapes are utilized to generate different electric-field distributions, thereby enabling variation of optical effects and viewing configurations.

### DETAILED DESCRIPTION OF THE INVENTION

Various embodiments of the present disclosure will now be described with reference to the accompanying drawings. In the following detailed description, numerous specific details are set forth in order to provide a more complete understanding of the disclosed embodiments. However, one of ordinary skill in the art will appreciate that the present disclosure may be practiced without one or more of these specific details. In other instances, well-known structures, components, methods, and processing techniques are not described in detail so as not to unnecessarily obscure aspects of the present disclosure.

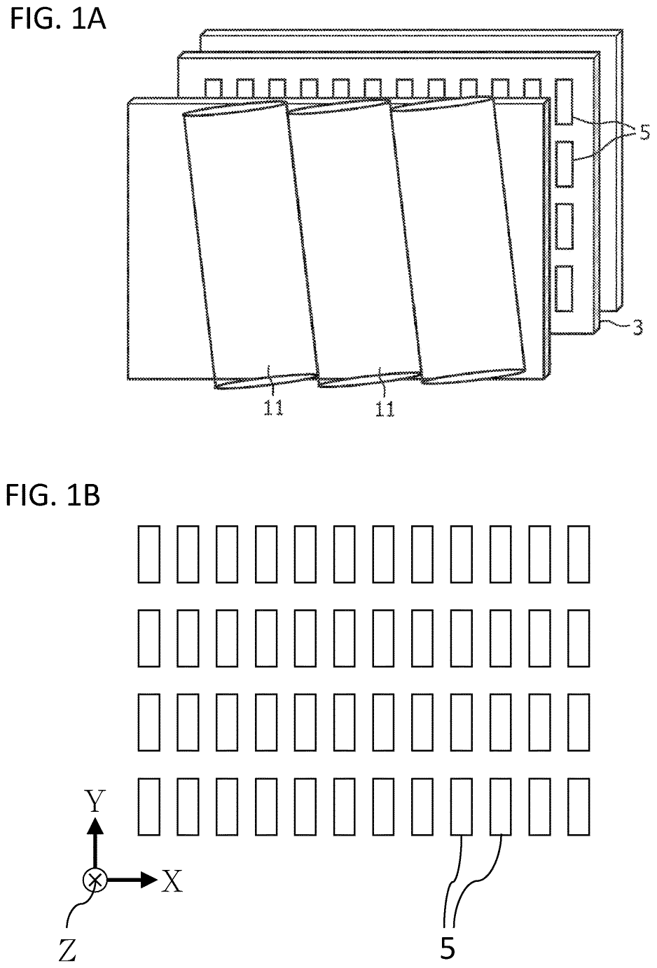

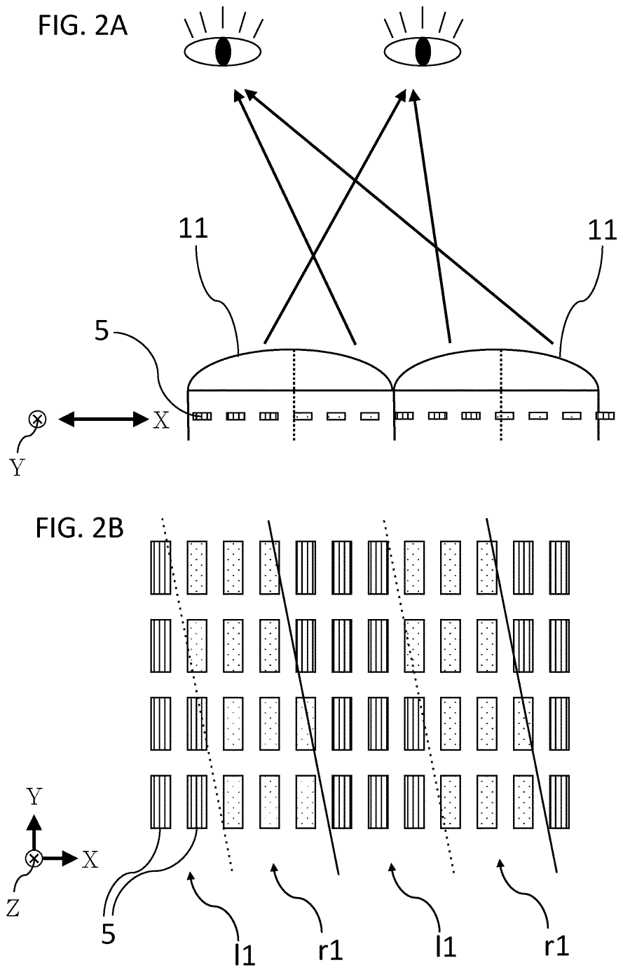

As illustrated in FIGS. 1A and 1B, a conventional autostereoscopic display device includes a display pixel array 3. The display pixel array 3 comprises a plurality of display pixels 5 arranged in rows and columns extending respectively along a row direction (X-axis) and a column direction (Y-axis). In addition, an array of optical elements 11 is disposed above the display pixel array 3 along a direction perpendicular to the X-axis and the Y-axis (i.e., along a Z-axis direction). The optical elements 11 extend parallel to one another and overlie the display pixel array 3. As shown in FIGS. 2A and 2B, different pixel groups (for example, pixel groups l1 and r1) may be directed to a viewer's left eye and right eye via the optical elements 11, thereby enabling glasses-free three-dimensional (3D) display. Techniques for directing different images to the left and right eyes may be found, for example, in U.S. Pat. No. 4,959,641, which discloses a stereoscopic display system capable of generating at least one pair of parallax images such that a viewer can perceive three-dimensional depth without wearing special glasses. The fundamental principle involves displaying two or more images having slight differences (parallax), such that the viewer's left and right eyes receive different images, thereby producing a stereoscopic visual perception.

However, the two-dimensional pixel array shown in FIG. 1B is originally capable of providing a resolution of 12×4, namely forty-eight display pixels 5, in a two-dimensional display mode. In contrast, in the three-dimensional pixel array shown in FIG. 2B, the forty-eight display pixels 5 need to be evenly allocated, in the three-dimensional display mode, to different pixel groups, such as l1 and r1, that are respectively directed toward the left eye and the right eye of a viewer. Therefore, in the three-dimensional display mode, one half of the resolution is inevitably lost.

The optical elements 11 are arranged at a predetermined inclination angle relative to the column direction (Y-axis) of the display pixels so as to optimize image separation performance. With this configuration, multiple pixel groups (for example, R1, R2, L1, and L2) may be repeatedly formed across the display surface, each pixel group being composed of adjacent display pixels 5. When a barrier or a lenticular lens having no inclination angle is used to generate multi-view images, the effective resolution of each view is reduced in the horizontal direction, while the resolution in the vertical direction remains unchanged. By introducing an inclination angle to the barrier or the lenticular lens, the resolution loss can be distributed between the horizontal and vertical directions, thereby improving overall image quality in practical applications.

The optical elements 11 may alternatively be implemented as liquid-crystal lenses, each including a plurality of lens units configured to form multiple pixel groups. Under optical operation, each lens unit is configured to form multiple pixel groups and to define boundaries between adjacent pixel groups, thereby producing the multi-view separation effect required for stereoscopic image generation. However, crosstalk may occur at the image boundaries. For any given pixel, an optimal brightness level may be determined based on a distance between the pixel and a nearest end of a boundary separating adjacent images. A processor may be configured to perform related operations, such as obtaining the distance between a display pixel and the nearest end of a boundary used to separate adjacent images. The display device may adjust pixel brightness according to the positional relationship of the pixel relative to the image boundary, such that the brightness of pixels located near the boundary is appropriately reduced. Such a method of dynamically adjusting pixel brightness based on the distance between pixels and image boundaries may be implemented in accordance with the techniques described in U.S. Pat. No. 12,366,765B1.

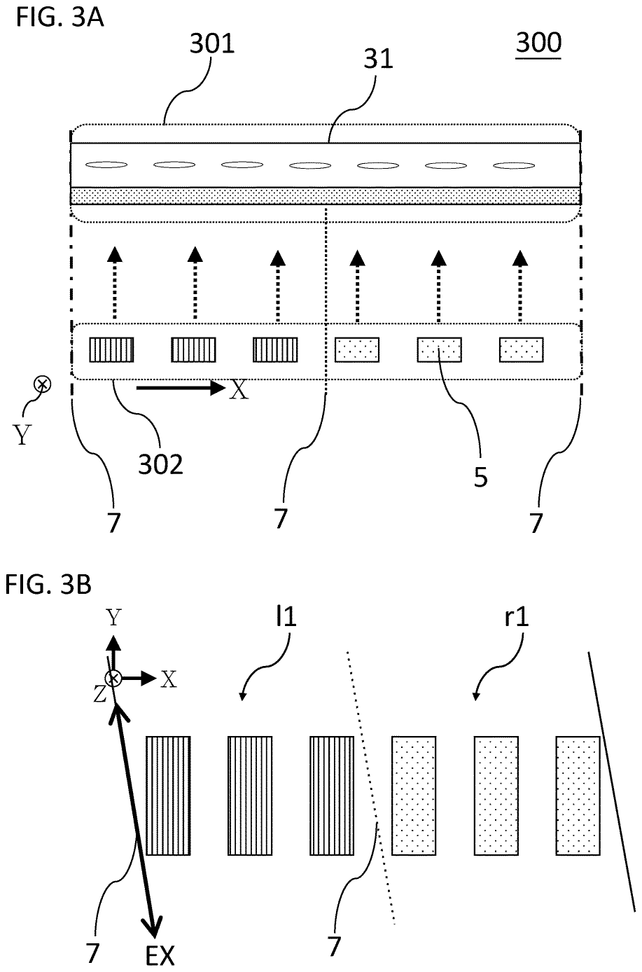

As illustrated in FIG. 3A, in one embodiment, an optical element of a display device 300 is implemented as a liquid crystal lens 301. The liquid crystal lens 301 is an electrically controllable optical component capable of reorienting liquid crystal molecules under an applied electric field so as to modulate a refractive-index distribution of a liquid crystal layer, thereby achieving optical functions such as focusing, beam deflection, or light steering. The liquid crystal lens 301 includes a plurality of electrically controllable lens units, wherein the liquid crystal layer is disposed between a first electrode layer and a second electrode layer. By applying a potential difference across the liquid crystal layer, a spatially graded refractive-index distribution is generated within the liquid crystal layer so as to produce a lens effect. Furthermore, by adjusting the applied electric potentials, characteristics of the lens units—such as size, shape, position, or orientation—may be selectively controlled.

Based on the above structure, and as shown in FIGS. 3A and 3B, the display device 300 further includes a display panel 302 configured to generate images. A plurality of display pixels 5 in the display panel 302 are arranged along a row direction X and a column direction Y. The liquid crystal lens 301 disposed above the display panel 302 includes a plurality of elongated lens units 31 extending parallel to one another along a lens direction EX, wherein the lens direction EX is oblique to the column direction Y and the row direction X. During optical imaging operation, the lens units 31 are configured to cause the display pixels to correspond optically to multiple pixel groups (for example, r1, l1, etc.) of the display panel 302, and to define optical boundaries 7 between adjacent pixel groups, thereby producing the multi-view separation effect required for autostereoscopic image display.

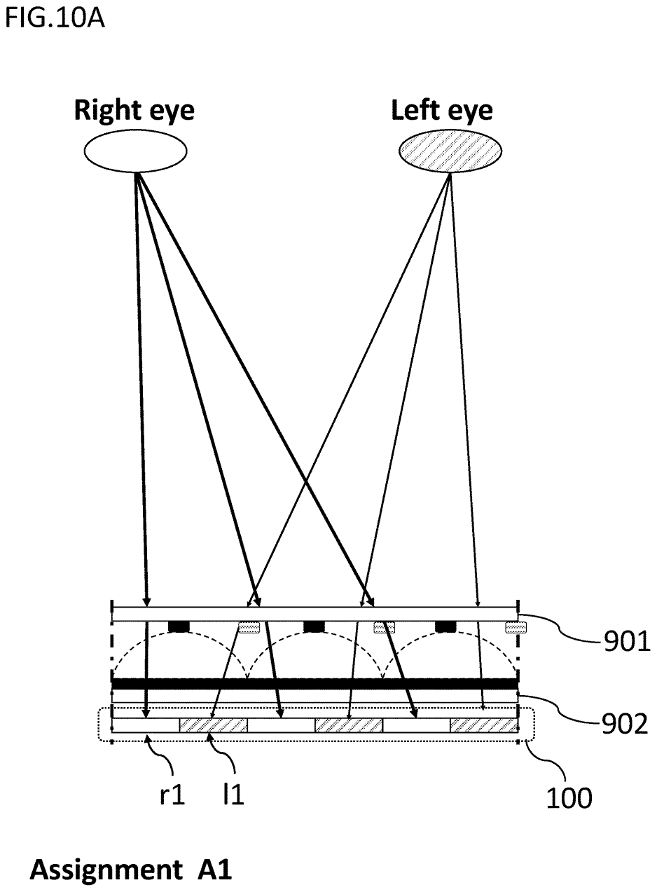

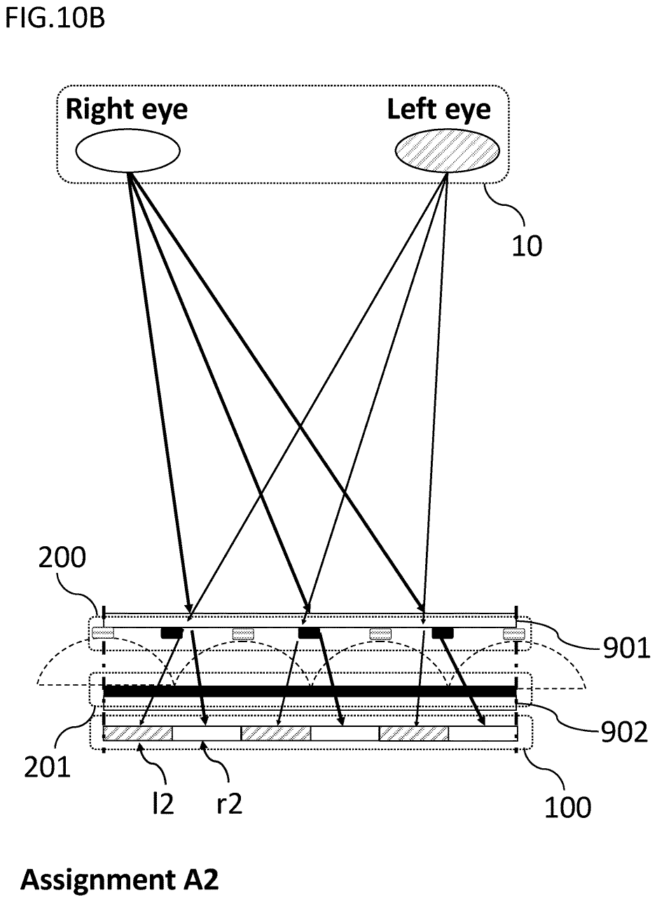

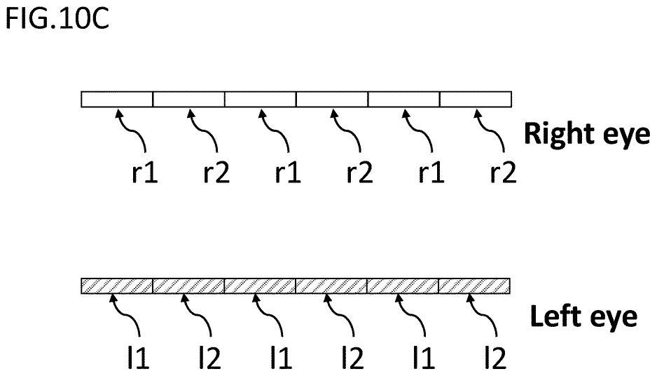

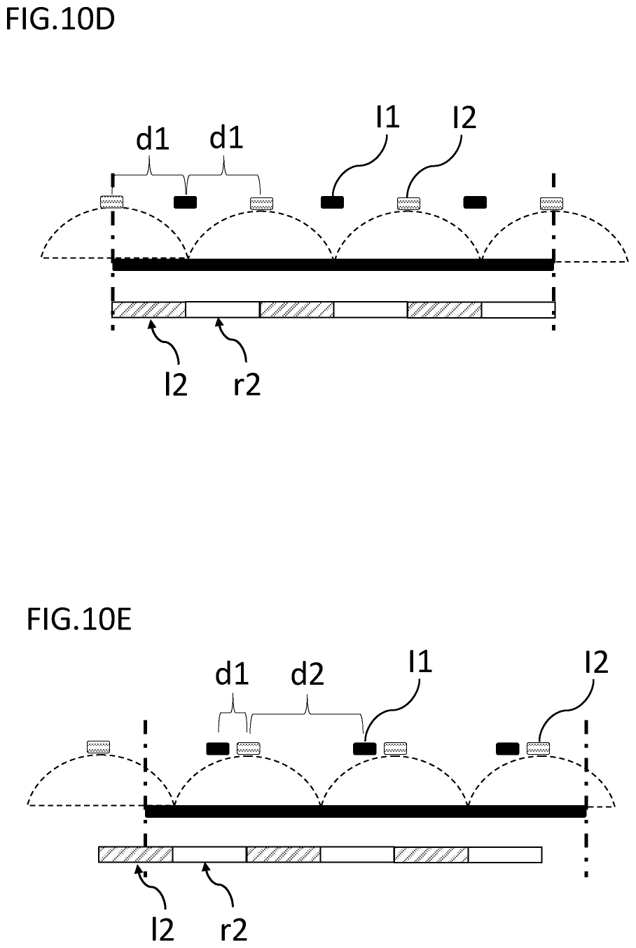

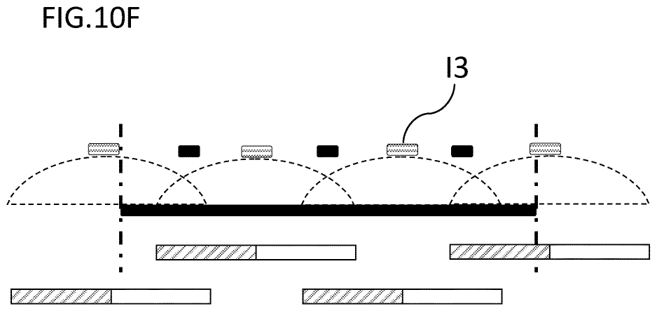

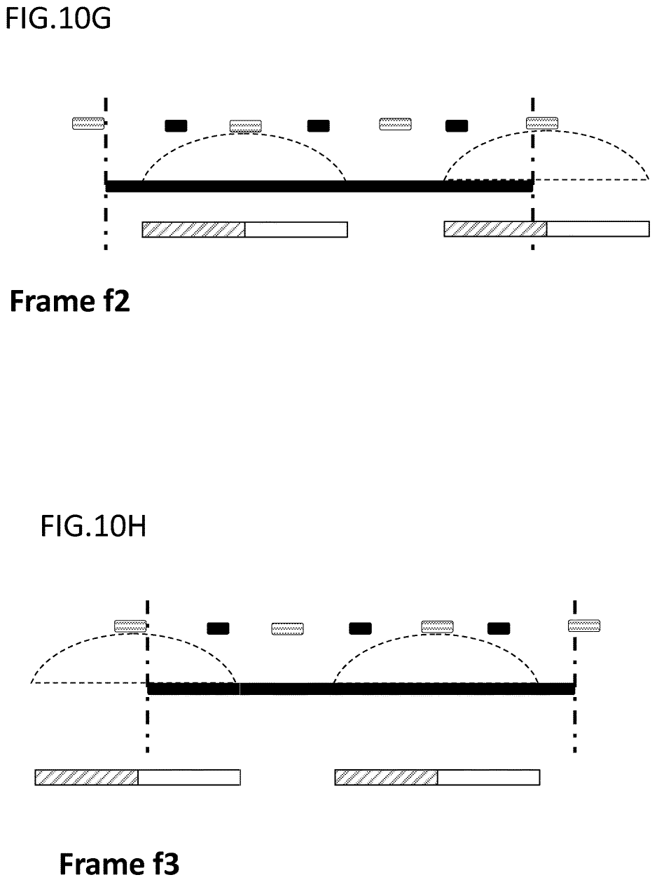

In some embodiments, as shown in FIGS. 10A through 10C, an autostereoscopic display system includes a display device 100, a liquid-crystal lens, and a control circuit. The display device 100 may be configured to display image content including a left-eye image and a right-eye image. The display device 100 may include a plurality of display pixels 5 arranged in rows and columns (as shown in FIG. 2B). In some embodiments, the display device 100 may be an LCD panel, an OLED panel, a micro-LED panel, or another suitable display panel. Each display pixel may correspond to a pixel, a sub-pixel, or a group of pixels or sub-pixels, depending on the pixel layout and the rendering method used by the display device.

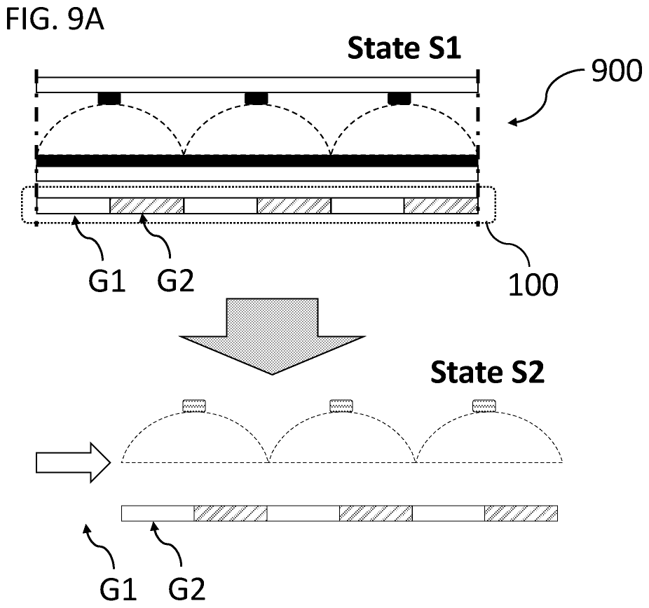

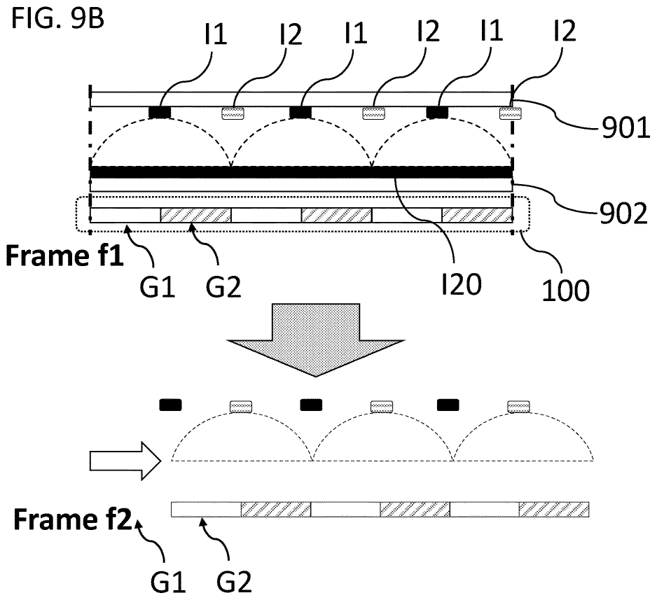

As shown in FIG. 3A, the liquid-crystal lens, which may correspond to the liquid crystal lens 301 shown in FIG. 3A, may be disposed on one side of the display device 100 (or display panel 302), for example in front of or above the display pixels along a light-emitting direction of the display device. The liquid crystal lens 301 may include a liquid crystal layer and a plurality of electrodes 200, 201 (as shown in FIG. 10B) configured to generate an electric field in the liquid crystal layer. In some embodiments, the electrodes may include a first electrode group I1 and a second electrode group I2 (as shown in FIG. 9B). The first electrode group I1 and the second electrode group I2 may be laterally offset from each other. For example, at least some electrodes of the first electrode group I1 may be located at different lateral positions from corresponding electrodes of the second electrode group I2. The electrode groups I1,I2 may be formed of a transparent conductive material, such as indium tin oxide (ITO), or another suitable conductive material.

By selectively driving the first electrode group I1 and/or the second electrode group I2, the liquid crystal lens 301 may generate different effective electric-field distributions in the liquid crystal layer. The different effective electric-field distributions may cause liquid crystal molecules in the liquid crystal layer to assume different orientation distributions, thereby forming different refractive-index distributions. As a result, an optical action region of the liquid crystal lens 301 may be laterally displaced. The optical action region may correspond to an effective lens center, a refractive-index-gradient region, a light-steering region, or another region of the liquid crystal lens 301 that optically directs light emitted from the display pixels toward one or more viewing zones (for example, one or more viewing zones G1 or G2 shown in FIG. 9B).

The control circuit may be coupled to the display device 100 and the liquid crystal lens 301. The control circuit may control the display device 100 to generate the left-eye image and the right-eye image. The left-eye image may be provided as a plurality of left-eye image segments, including at least a first left-eye image segment l1 and a second left-eye image segment l2. Similarly, the right-eye image may be provided as a plurality of right-eye image segments, including at least a first right-eye image segment r1 and a second right-eye image segment r2. The image segments may correspond to different pixel positions, pixel groups, display regions, columns, rows, sub-pixel groups, or other portions of the displayed image content.

During a plurality of first periods (for example, in frames 1, 3, 5, . . . ), the control circuit may control the display device 100 according to a first pixel assignment A1. Under the first pixel assignment A1 (as shown in FIG. 10A), the first left-eye image segment l1 and the first right-eye image segment r1 may be displayed in an interleaved arrangement by the plurality of display pixels 5. For example, a first set of display pixels 5 or pixel positions may display right-eye image information, and a second set of display pixels 5 or pixel positions may display left-eye image information. The first set and the second set may be arranged alternately, periodically, or otherwise interleaved across the display device 100. During the first periods, the control circuit may also drive the first electrode group I1 to operate the liquid crystal lens 301 in a first lens state S1 (as shown in FIG. 9A). In the first lens state S1, the liquid crystal lens 301 directs light from the first left-eye image segment l1 toward a left eye of a viewer and directs light from the first right-eye image segment r1 toward a right eye of the viewer.

During a plurality of second periods (for example, in frames 2, 4, 6, . . . ) alternating with the plurality of first periods, the control circuit may control the display device 100 according to a second pixel assignment A2 (as shown in FIG. 10B). Under the second pixel assignment A2, the second left-eye image segment l2 and the second right-eye image segment r2 may also be displayed in an interleaved arrangement by the plurality of display pixels 5. However, the pixel positions used in the second pixel assignment A2 may be laterally different from the pixel positions used in the first pixel assignment A1 (as shown in FIGS. 10D and 10E). For example, the second pixel assignment A2 may shift or exchange the pixel positions used for left-eye image information and right-eye image information relative to the first pixel assignment A1.

In some embodiments, in an edge region of the liquid crystal lens 301, the first electrode group I1 and the second electrode group I2 may be arranged with asymmetric lateral distances, such that an incomplete electric-field formation region near the edge region is reduced as shown in FIGS. 10D and 10E.

During the second periods, the control circuit may drive the second electrode group I2 to operate the liquid crystal lens 301 in a second lens state S2 (as shown in FIG. 9A). Since the first electrode group I1 and the second electrode group I2 are laterally offset from each other, driving the second electrode group I2 may produce an effective electric-field distribution different from that produced by driving the first electrode group I1. The second lens state S2 may therefore laterally displace the optical action region of the liquid crystal lens 301 relative to the first lens state S1. The laterally displaced optical action region may direct light from the second left-eye image segment l2 toward the left eye of the viewer and direct light from the second right-eye image segment r2 toward the right eye of the viewer, even though the second left-eye image segment l2 and the second right-eye image segment r2 are displayed at pixel positions different from those used in the first pixel assignment A1 (as shown in FIG. 10E).

In some embodiments, the amount by which the optical action region is laterally displaced in the second lens state S2 may correspond to a positional difference between the first pixel assignment A1 and the second pixel assignment A2. The positional difference may refer to a lateral offset between pixel positions used to display left-eye image information or right-eye image information in the first pixel assignment A1 and pixel positions used to display corresponding left-eye image information or right-eye image information in the second pixel assignment A2. For example, if a first pixel position is used for right-eye image information in the first pixel assignment A1 and for left-eye image information in the second pixel assignment A2, and a second pixel position is used for left-eye image information in the first pixel assignment A1 and for right-eye image information in the second pixel assignment A2, the positional difference may correspond to a lateral offset between the first and second pixel positions or between corresponding pixel groups.

The amount of lateral displacement of the optical action region need not be equal to a physical pixel pitch. In various embodiments, the amount may correspond to a full pixel pitch, a sub-pixel pitch, a fraction of a pixel pitch, a pitch between pixel groups, or an optically equivalent displacement. The amount may be determined according to one or more parameters, such as a pixel pitch of the display device, a lateral offset between the first electrode group I1 and the second electrode group I2, an electrode pitch, a cell gap of the liquid crystal layer, a refractive-index distribution generated in the liquid crystal layer, a viewing distance, or a target viewing zone. In some embodiments, the amount may be determined by design, calibration, a lookup table, or real-time control performed by the control circuit.

In some embodiments, the plurality of first periods and the plurality of second periods may correspond to alternating display frames. For example, the first periods may include odd-numbered frames, such as frames 1, 3, 5 . . . , and the second periods may include even-numbered frames, such as frames 2, 4, 6 . . . . In other embodiments, the first periods and the second periods may correspond to other temporal intervals, such as groups of frames, sub-frame intervals, refresh periods, or time slots determined according to a display refresh rate or a threshold of viewer perception.

In some embodiments, the temporal interval of the plurality of first periods and the plurality of second periods may be determined according to a threshold of viewer perception. The threshold of viewer perception may refer to a temporal threshold, a flicker perception threshold, a temporal image-fusion threshold, a motion perception threshold, or another perceptual threshold at which alternating display states are perceived by a viewer as a substantially continuous image rather than as separate or flickering images.

For example, the control circuit may determine a duration, a repetition rate, or a switching frequency of the first periods and the second periods according to a display refresh rate and the threshold of viewer perception. When the display device operates at a sufficiently high refresh rate, the control circuit may alternate the first pixel assignment A1 and the second pixel assignment A2 within a time interval short enough that the viewer perceives the alternation as a continuous stereoscopic image. Accordingly, the viewer's left eye may receive the first left-eye image segment l1 and the second left-eye image segment l2 over different periods, and the viewer's right eye may receive the first right-eye image segment r1 and the second right-eye image segment r2 over different periods, without perceiving significant flicker caused by the alternation.

In some embodiments, the threshold of viewer perception may be predetermined, measured, estimated, or adaptively adjusted. For example, the threshold may be stored in a lookup table, determined according to a display refresh rate, determined according to brightness or contrast of the displayed image content, determined according to a viewing distance, or adjusted according to detected viewer conditions. In some embodiments, the control circuit may select the temporal intervals of the first periods and the second periods such that a switching frequency between the first pixel assignment A1 and the second pixel assignment A2 is higher than a perceptible flicker threshold of the viewer. In other embodiments, the control circuit may select the temporal intervals such that the alternation between the first and second pixel assignments is temporally integrated by the viewer's visual system.

In some embodiments, the threshold of viewer perception may be used together with the display refresh rate to determine whether the first periods and the second periods correspond to individual frames, groups of frames, sub-frame intervals, refresh periods, or other time slots. For example, when the display refresh rate is sufficiently high, the first periods may correspond to odd-numbered frames and the second periods may correspond to even-numbered frames. When a different refresh rate or different image condition is used, each first period or second period may include a group of frames or a sub-frame interval. In this manner, the timing of the pixel-assignment switching and the lens-state switching may be selected so that the viewer perceives a stable stereoscopic image while receiving spatial image information from different display pixels over time.

By alternately performing the first pixel assignment A1 and the second pixel assignment A2, the control circuit may cause the left eye of the viewer to receive left-eye image information from different display pixels in different periods. Similarly, the control circuit may cause the right eye of the viewer to receive right-eye image information from different display pixels in different periods. Accordingly, each eye may receive different spatial image information over multiple periods, while the liquid crystal lens 301 maintains optical separation between the left-eye image and the right-eye image. This coordinated operation of pixel assignment switching and lens-state switching may reduce an effective per-eye resolution loss that would otherwise occur in a conventional autostereoscopic display operation, and may improve perceived stereoscopic image quality.

In some embodiments, the first pixel assignment A1 and the second pixel assignment A2 may be repeated periodically. In other embodiments, additional pixel assignments and additional lens states may be used. For example, three or more electrode groups may be provided (as shown in FIG. 10F), and the control circuit may switch among three or more lens states corresponding to three or more pixel assignments. Such additional pixel assignments and lens states may further distribute left-eye image information and right-eye image information among different display pixels over time, while maintaining proper optical routing to the viewer's left eye and right eye.

In some embodiments, the system is not limited to two pixel assignments or two lens states. The liquid crystal lens 301 may include three or more electrode groups that are laterally offset from one another, and the control circuit may selectively drive the three or more electrode groups to generate three or more corresponding effective electric-field distributions in the liquid crystal layer. The three or more effective electric-field distributions may produce three or more lens states, each of which laterally positions or displaces an optical action region of the liquid crystal lens 301 in a manner corresponding to a respective pixel assignment.

For example, in addition to the first pixel assignment A1 and the second pixel assignment A2, the control circuit may perform a third pixel assignment A3 during a plurality of third periods. In the third pixel assignment A3, left-eye image information and right-eye image information may be displayed at pixel positions different from those used in the first pixel assignment A1 and the second pixel assignment A2. The control circuit may drive a third electrode group to operate the liquid crystal lens 301 in a third lens state S3. In the third lens state S3, the optical action region of the liquid crystal lens 301 may be laterally positioned or laterally displaced so that the left-eye image information displayed according to the third pixel assignment A3 is directed toward the left eye of the viewer and the right-eye image information displayed according to the third pixel assignment A3 is directed toward the right eye of the viewer.

The first, second, and third pixel assignments A1, A2, and A3 may be performed sequentially, periodically, or according to a predetermined or adaptive temporal order. For example, the control circuit may perform the first pixel assignment A1 during first periods, the second pixel assignment A2 during second periods, and the third pixel assignment A3 during third periods, while synchronously switching the liquid crystal lens 301 among the first, second, and third lens states S1, S2, and S3. In other embodiments, more than three pixel assignments and more than three lens states may be used.

By using three or more pixel assignments and three or more corresponding lens states, the system may distribute left-eye image information and right-eye image information among a larger number of display pixels over time. Accordingly, the left eye of the viewer may receive left-eye image information from three or more different sets of display pixels in different periods, and the right eye of the viewer may receive right-eye image information from three or more different sets of display pixels in different periods. Because each lens state is coordinated with a corresponding pixel assignment, the liquid crystal lens 301 may maintain optical routing of the left-eye image information and the right-eye image information to the corresponding eyes of the viewer while increasing the amount of spatial image information delivered to each eye over time.

In some embodiments, the control circuit coordinates a change in a pixel assignment of the display device with a corresponding change in the lens state of the liquid crystal lens 301. For example, during the first period, the first pixel assignment A1 may cause the first left-eye image segment l1 and the first right-eye image segment r1 to be displayed at respective first pixel positions of the display device. The first electrode group I1 may be driven to establish a first effective electric-field distribution in the liquid crystal layer, thereby causing the liquid crystal lens 301 to operate in the first lens state S1. In the first lens state S1, the optical action region of the liquid crystal lens 301 is positioned to direct light from the first left-eye image segment l1 toward a left eye of a viewer and to direct light from the first right-eye image segment r1 toward a right eye of the viewer.

During the second period, the second pixel assignment A2 may cause the second left-eye image segment l2 and the second right-eye image segment r2 to be displayed at respective second pixel positions of the display device. The second pixel positions used in the second pixel assignment A2 may be laterally different from the first pixel positions used in the first pixel assignment A1. For example, a pixel or pixel group that displays right-eye image information during the first period may display left-eye image information during the second period, and another pixel or pixel group that displays left-eye image information during the first period may display right-eye image information during the second period. Accordingly, the second pixel assignment A2 may have a lateral positional difference relative to the first pixel assignment A1.

To maintain correct optical routing after the pixel assignment is changed, the control circuit may drive the second electrode group I2 to establish a second effective electric-field distribution in the liquid crystal layer. The second effective electric-field distribution may cause the liquid crystal lens 301 to operate in the second lens state S2 in which the optical action region of the liquid crystal lens 301 is laterally displaced relative to the optical action region in the first lens state S1. The lateral displacement of the optical action region may correspond to the positional difference between the first pixel assignment A1 and the second pixel assignment A2. As used herein, the displacement “corresponds to” the positional difference when the displacement is selected, calculated, calibrated, or otherwise configured to compensate for a lateral offset between pixel positions used in the first pixel assignment A1 and pixel positions used in the second pixel assignment A2, such that image information displayed at the second pixel positions is still directed to the intended eye of the viewer.

In some embodiments, the amount of lateral displacement of the optical action region need not be equal to a physical pixel pitch. The amount may correspond to a full pixel pitch, a sub-pixel pitch, a fraction of a pixel pitch, a pixel-group pitch, or an optically equivalent displacement determined according to parameters of the display device and the liquid-crystal lens. Such parameters may include, for example, a pixel pitch of the display device, a lateral offset between the first electrode group and the second electrode group, an electrode pitch, a cell gap of the liquid crystal layer, a refractive-index distribution generated in the liquid crystal layer, a viewing distance, and/or a target viewing zone. In some embodiments, the corresponding displacement may be determined by design, calibration, a lookup table, or real-time control performed by the control circuit.

By coordinating the lateral displacement of the optical action region with the positional difference between the first pixel assignment A1 and the second pixel assignment A2, the system may allow the viewer's left eye to receive left-eye image information from different pixel positions in different periods and may allow the viewer's right eye to receive right-eye image information from different pixel positions in different periods. Thus, even though the pixels used to display the left-eye image information and the right-eye image information are changed between the first periods and the second periods, the liquid-crystal lens may maintain optical separation between the left-eye image and the right-eye image and may reduce optical mismatch or crosstalk caused by the change in pixel assignment.

In some embodiments, the display system includes a display and the liquid crystal lens 301 disposed on one side of the display. The display may include the plurality of display pixels 5, such as pixels of an LCD panel, an OLED panel, or another display panel. The liquid crystal lens 301 may include the liquid crystal layer and the plurality of electrodes, such as the first electrode group I1 and the second electrode group I2. The electrodes may be formed of indium tin oxide (ITO) or another conductive material. The first electrode group I1 and the second electrode group I2 may be arranged at laterally different positions relative to the display pixels 5, such that driving different electrode groups produces different effective electric-field distributions in the liquid crystal layer.

In one example, the display pixels may include first pixels or first pixel positions and second pixels or second pixel positions. During the first set of periods, such as odd-numbered frames including frames 1, 3, and 5, the control circuit may drive the first electrode group I1 to an active state and may drive the second electrode group I2 to an inactive state. During the first set of periods, the control circuit may further control the display device according to the first pixel assignment A1 in which the first pixels or first pixel positions display right-eye image information and the second pixels or second pixel positions display left-eye image information. The effective electric-field distribution generated by the first electrode group I1 may cause the liquid crystal lens 301 to operate in the first lens state S1, in which light from the left-eye image information is directed toward the left eye of the viewer and light from the right-eye image information is directed toward the right eye of the viewer.

During the second set of periods alternating with the first set of periods, such as even-numbered frames including frames 2, 4, and 6, the control circuit may drive the first electrode group I1 to an inactive state and may drive the second electrode group I2 to an active state. During the second set of periods, the control circuit may further control the display device according to the second pixel assignment A2 in which the first pixels or first pixel positions display left-eye image information and the second pixels or second pixel positions display right-eye image information. Thus, the pixels or pixel positions used to display the left-eye image information and the right-eye image information are changed between the first pixel assignment A1 and the second pixel assignment A2.

The change from the first pixel assignment A1 to the second pixel assignment A2 may define a positional difference between pixel positions used for the left-eye image information and pixel positions used for the right-eye image information in different periods. For example, when the first pixel positions display right-eye image information and the second pixel positions display left-eye image information in the first set of periods, and the first pixel positions display left-eye image information and the second pixel positions display right-eye image information in the second set of periods, the left-eye and right-eye image information are effectively shifted or reassigned between different lateral pixel positions. The positional difference may correspond to a pixel pitch, a sub-pixel pitch, a fraction of a pixel pitch, a pitch between pixel groups, or another optically equivalent lateral offset.

In some embodiments, the positional difference between the first pixel assignment A1 and the second pixel assignment A2 may be defined based on a lateral relationship between pixel positions used in different periods. For example, the positional difference may include a lateral offset between a pixel position used to display left-eye image information or right-eye image information in the first pixel assignment A1 and a corresponding pixel position used to display the left-eye image information or the right-eye image information in the second pixel assignment A2.

In one example, during the first set of periods, a first pixel position may display right-eye image information and a second pixel position may display left-eye image information. During the second set of periods, the first pixel position may display left-eye image information and the second pixel position may display right-eye image information. In this manner, the left-eye image information and the right-eye image information are reassigned between different lateral pixel positions in different periods.

The positional difference may therefore correspond to a lateral offset between the first pixel position and the second pixel position, or between corresponding pixel groups including the first pixel position and the second pixel position. In some embodiments, the lateral offset may correspond to a pixel pitch, a sub-pixel pitch, a fraction of a pixel pitch, a pixel-group pitch, or an optically equivalent lateral offset. The control circuit may coordinate the lens state of the liquid crystal lens 301 with the positional difference so that, after the pixel positions for the left-eye image information and the right-eye image information are changed, the liquid crystal lens 301 still directs the left-eye image information toward the left eye of the viewer and directs the right-eye image information toward the right eye of the viewer.

To compensate for the positional difference caused by the change in pixel assignment, the liquid crystal lens 301 may be switched from the first lens state S1 to the second lens state S2. The second lens state S2 may be generated by driving the second electrode group I2 instead of the first electrode group I1, thereby changing the effective electric-field distribution in the liquid crystal layer. The change in the effective electric-field distribution may alter a refractive-index distribution of the liquid crystal layer and laterally displace an optical action region of the liquid crystal lens 301 relative to the optical action region in the first lens state S1. In some embodiments, the optical action region may correspond to an effective lens center, a refractive-index-gradient region, a light-steering region, or another region of the liquid crystal lens 301 that optically directs light from the display pixels toward viewing zones (for example, G1 or G2 shown in FIG. 9B).

The amount of lateral displacement of the optical action region may correspond to the positional difference between the first pixel assignment A1 and the second pixel assignment A2. In this context, the displacement need not be physically equal to the physical distance between pixel positions used in the first pixel assignment A1 and pixel positions used in the second pixel assignment A2. Rather, the displacement may be selected, calculated, adjusted, calibrated, or otherwise configured so that the optical routing of the liquid crystal lens remains matched with the display pixels used in the current pixel assignment. Accordingly, when the second pixel assignment A2 is used, the laterally displaced optical action region in the second lens state S2 may direct the left-eye image information displayed at the reassigned pixel positions toward the left eye of the viewer and may direct the right-eye image information displayed at the reassigned pixel positions toward the right eye of the viewer.

In some embodiments, the control circuit may alternately perform the first pixel assignment A1 and the second pixel assignment A2 while synchronously switching the liquid crystal lens 301 between the first lens state S1 and the second lens state S2. As a result, the viewer's left eye may receive left-eye image information from different display pixels in different periods, and the viewer's right eye may receive right-eye image information from different display pixels in different periods. By coordinating the pixel assignment of the display device with the lens state of the liquid crystal lens 301, the system may increase the amount of spatial image information delivered to each eye over multiple periods while maintaining optical separation between the left-eye image and the right-eye image.

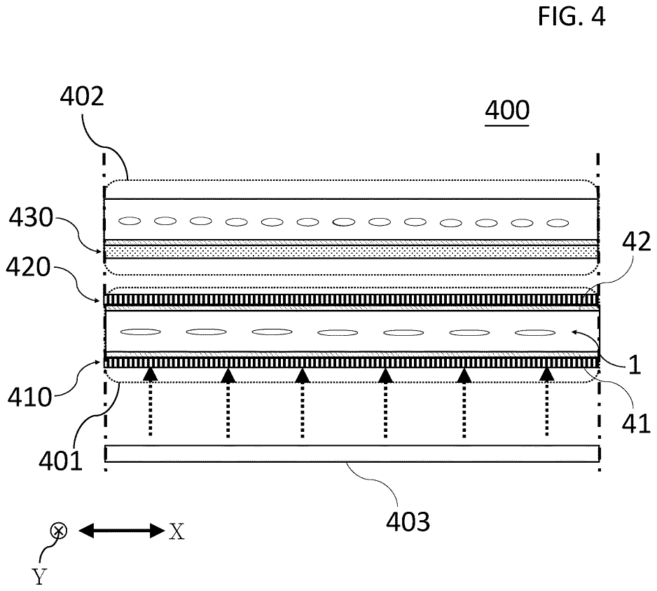

As shown in FIG. 4, in another embodiment, image generation may be implemented using a liquid-crystal panel 401. To enhance brightness and visibility, the liquid-crystal panel 401 may include a first alignment layer 41 and a first liquid-crystal layer 1 disposed between the first alignment layer 41 and a second alignment layer 42. The alignment direction of the first alignment layer 41 is substantially orthogonal to the alignment direction of the second alignment layer 42, thereby supporting a twisted-nematic (TN) configuration in which liquid-crystal molecules rotate the polarization direction of light as the light passes therethrough. The autostereoscopic display device 400 may further include a backlight module 403, a first polarizer 410 disposed between the backlight module 403 and the first alignment layer 41, and a second polarizer 420 disposed above the second alignment layer 42. In addition, a half-wave plate 430 may be disposed above the second polarizer 420.

A liquid-crystal lens has an optical axis determined by the principal alignment orientation of liquid-crystal molecules. Since liquid-crystal materials are birefringent, a liquid-crystal lens exhibits optimal optical performance for incident light having a polarization direction aligned with the optical axis. When the polarization direction of incident light is not aligned with the optical axis, the effective refractive-index distribution of the lens may be adversely affected, resulting in focal-length deviation and image crosstalk. Therefore, in order to align the polarization direction of incident light with the optical axis of the liquid-crystal lens, a polarization-compensation element—such as a half-wave plate—may be employed to rotate the polarization direction of the incident light, thereby ensuring optimal imaging performance of the liquid-crystal lens.

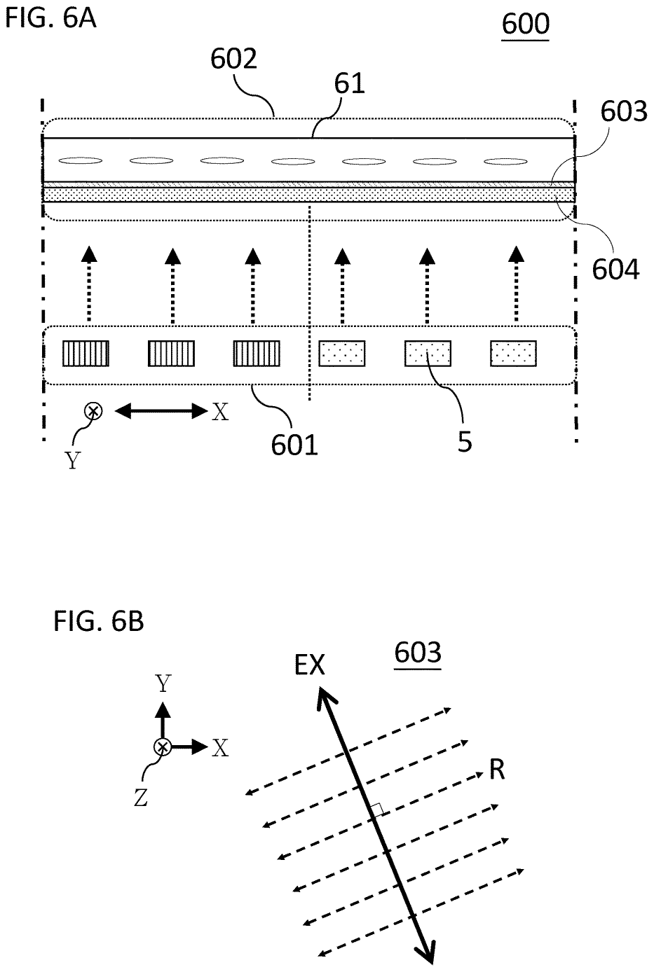

An array of liquid-crystal lens units may be disposed above the half-wave plate 430. The array includes a plurality of lens units extending along a lens direction EX and forming multiple pixel groups separated by image boundaries between adjacent images. The lens units extend parallel to one another and overlie the display pixels. Each lens unit has a lens direction EX extending across the pixel row direction and is arranged at a fixed inclination angle relative to the row direction of the pixel array. As illustrated in FIG. 6B, a third alignment layer disposed within the liquid-crystal layer of the liquid-crystal lens 402 has an alignment direction R that is substantially perpendicular to the lens direction EX. The third alignment layer is disposed between the half-wave plate 430 and the liquid-crystal layer of the liquid-crystal lens 402.

In liquid-crystal displays (LCDs), the term “alignment direction” generally refers to a predetermined orientation imparted to liquid-crystal molecules by an alignment layer. The alignment layer is typically a polymer thin film formed on a substrate surface, the surface of which is subjected to a mechanical rubbing process to create fine micro-groove structures. The rubbing process may be performed by sweeping a velvet cloth or a similar material across the surface of the alignment layer in a single direction, thereby causing molecular chains on the surface to become regularly aligned along that direction.

After rubbing, the alignment layer exerts surface anchoring forces on adjacent liquid-crystal molecules, causing the liquid-crystal molecules to tend to align uniformly along the rubbing direction (i.e., the alignment direction) in the absence of an externally applied electric field. As a result, the liquid-crystal layer exhibits stable and predictable optical characteristics in an initial state. Such an alignment process is a critical step for achieving stable optical response and proper display operation in liquid-crystal devices.

Because the lens units of the liquid-crystal lens in the present invention are arranged at a fixed inclination angle relative to a row direction of a display-pixel array, an effective optical axis formed by the liquid-crystal lens under an applied operating electric field does not necessarily coincide with an optical axis of a polarizer disposed on the liquid-crystal panel. When a polarization direction of incident light is not aligned with the effective optical axis of the liquid-crystal lens, polarization mismatch is likely to occur, which may lead to degraded polarization control performance, reduced contrast ratio, increased optical noise, and even image crosstalk or overall degradation of display quality.

To address the foregoing issues, the present invention disposes a half-wave plate between the polarizer and the liquid-crystal lens. The half-wave plate is configured to rotate a polarization direction of linearly polarized light emitted from the polarizer, such that the rotated polarization direction is aligned with the effective optical axis of the liquid-crystal lens.

By appropriately setting a fast-axis angle of the half-wave plate, polarization-axis mismatch between the polarizer and the liquid-crystal lens can be effectively compensated. Through the above-described polarization compensation mechanism, the present invention significantly improves a polarization state of light incident on the liquid-crystal lens, enhances polarization utilization efficiency, and reduces optical distortions caused by polarization mismatch. As a result, the display device achieves higher contrast, improved luminance uniformity, and superior overall image quality. In addition, such an optical-axis alignment mechanism helps reduce crosstalk during stereoscopic display operation, thereby enabling clearer and more stable stereoscopic visual effects in multi-view autostereoscopic display modes.

Based on the foregoing structure, as illustrated in FIG. 4, a half-wave plate 430 is disposed between the polarizer 420 and the liquid-crystal lens 402. Because the lens units of the liquid-crystal lens are arranged at a fixed inclination angle relative to a row direction of the pixel array, liquid-crystal molecules within the liquid-crystal lens are reoriented along a predetermined alignment direction under an applied driving electric field. As a result, an anisotropic refractive-index distribution is formed within the liquid-crystal layer, thereby establishing an effective optical axis associated with a principal molecular alignment direction of the liquid-crystal molecules.

This effective optical axis is generally not coincident with a transmission axis of the polarizer 420 disposed in the liquid-crystal panel. When a polarization direction of light incident on the liquid-crystal lens is not aligned with the effective optical axis, the birefringent nature of the liquid-crystal material causes reduced polarization-coupling efficiency, resulting in polarization mismatch. Such polarization mismatch may manifest as reduced contrast ratio, luminance loss, increased optical noise, and even image crosstalk, thereby degrading overall display quality. To address the above issues, the present invention introduces the half-wave plate 430 to rotate a polarization direction of linearly polarized light output from the polarizer 420, such that the rotated polarization direction is aligned with the effective optical axis formed in the liquid-crystal lens under the applied electric field, thereby achieving polarization compensation.

Specifically, when a fast axis of the half-wave plate 430 forms an angle θ with respect to an incident linear polarization direction, the polarization direction after passing through the half-wave plate is rotated by 2θ. By appropriately selecting an orientation angle of the fast axis of the half-wave plate 430, the rotated polarization direction can be made substantially coincident with the effective optical axis determined by the molecular alignment of the liquid-crystal lens.

Accordingly, the polarization direction of transmitted light is further maintained substantially parallel to an alignment direction R of a third alignment layer, thereby significantly reducing polarization mismatch effects. Through the above-described polarization-compensation and optical-axis-matching mechanism, the present invention effectively improves a polarization state of light incident on the liquid-crystal lens, enhances polarization utilization efficiency, and reduces optical distortions caused by polarization mismatch. As a result, the display device achieves higher contrast, improved luminance uniformity, and significantly reduced crosstalk during multi-view autostereoscopic display operation, thereby providing a more stable and clearer glasses-free stereoscopic visual experience.

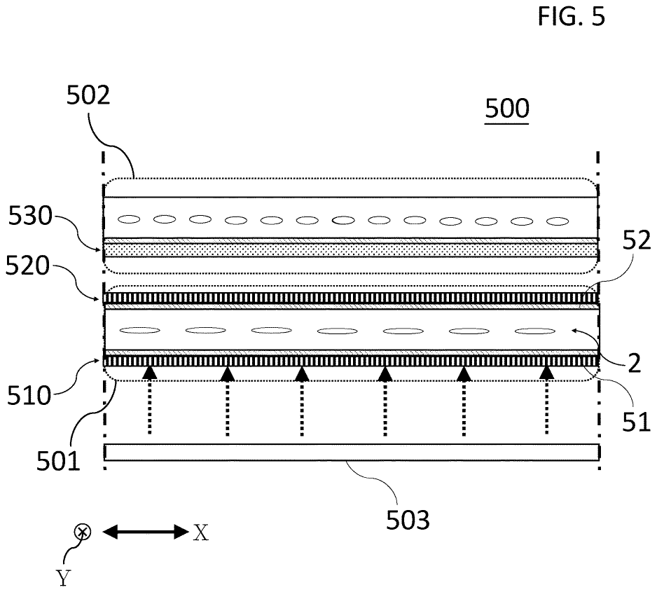

As shown in FIG. 5, in another embodiment a display device 500 may include a liquid-crystal panel 501 for displaying images. The liquid-crystal panel 501 may include a first alignment layer 51 and a liquid-crystal layer 2 disposed between the first alignment layer 51 and another alignment layer 52. The alignment layer 52 is disposed above the alignment layer 51, and the alignment direction of the alignment layer 51 is substantially orthogonal to the alignment direction of the alignment layer 52.

The display device 500 may further include a backlight module 503, and a polarizer 510 disposed between the backlight module 503 and the alignment layer 51. The polarizer 510 is configured to cause a polarization direction of light entering the liquid-crystal layer 2 to be substantially parallel to the alignment direction of the alignment layer 51. Another polarizer 520 may be disposed above the alignment layer 52, such that a polarization direction of light exiting the liquid-crystal layer 2 is substantially parallel to the alignment direction of the alignment layer 52.

A liquid-crystal lens 502 is disposed above the polarizer 520 and may be arranged at a predetermined fixed inclination angle relative to a pixel row direction X or a pixel column direction Y of the display surface (for example, as shown in FIG. 3B). A half-wave plate 530 is disposed between the liquid-crystal lens 502 and the liquid-crystal panel 501, configured to cause a polarization direction of light entering the liquid-crystal lens 502 to be substantially parallel to an alignment direction of an alignment layer within a second liquid-crystal layer of the liquid-crystal lens 502. An angular difference between an optical axis of the polarizer 520 and an input optical axis of the liquid-crystal lens 502 is approximately twice an angular difference between the optical axis of the polarizer 520 and an optical axis of the half-wave plate 530.

As shown in FIGS. 6A and 6B, in another embodiment, an autostereoscopic display device 600 includes a plurality of display pixels 5 arranged in a matrix configuration, that is, an image is divided into multiple pixels arranged in a two-dimensional matrix, with each pixel carrying color values such as RGB components. The display pixels 5 may be provided by a liquid crystal display (LCD) panel, an organic light-emitting diode (OLED) panel, or other suitable display technologies 601. Disposed above the display pixels 5 is a liquid-crystal lens structure 602, which includes a plurality of elongated liquid-crystal lens units 61. The lens units 61 extend parallel to one another along a lens direction EX that intersects a column direction Y of the display-pixel array.

The liquid-crystal lens structure 602 further includes a third alignment layer 603. The third alignment layer 603 is subjected to an alignment treatment to form a specific alignment direction R, and the alignment direction R is substantially perpendicular to the lens direction EX. Such an alignment configuration ensures that liquid-crystal molecules within the liquid-crystal lens structure 602 assume a correct and stable orientation, thereby providing the optical characteristics required for stereoscopic image separation. A half-wave plate 604 is disposed between the display pixels 5 and the liquid-crystal lens units 61. The half-wave plate 604 is configured to rotate a polarization direction of transmitted light so as to align the polarization direction with the alignment direction R. Through such polarization control, the optical performance of the liquid-crystal lens is optimized, thereby improving image clarity and contrast.

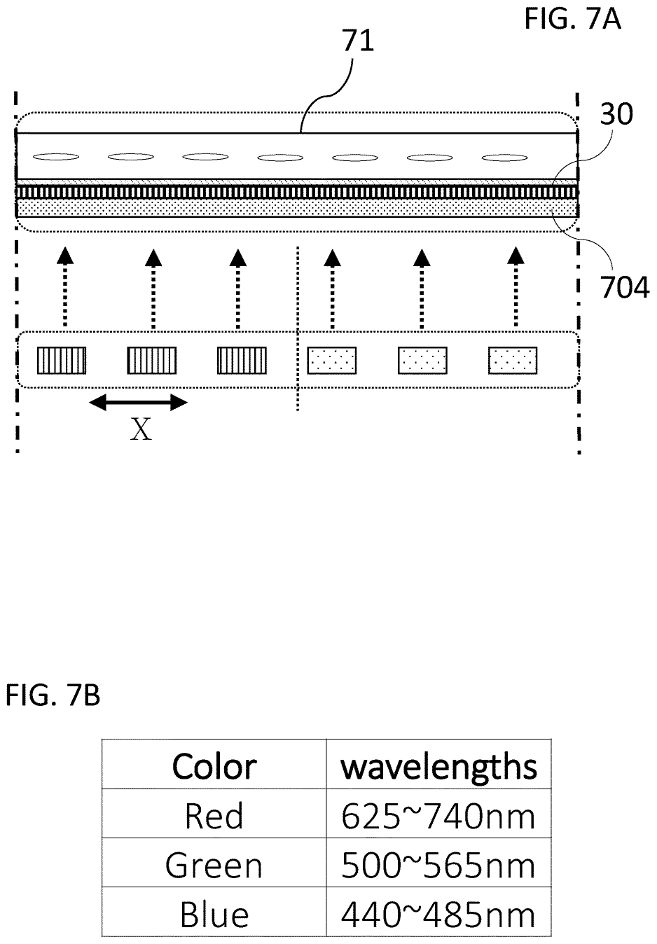

As shown in FIG. 7A, in another embodiment, the autostereoscopic display device may further include a third polarizer 30 disposed between the half-wave plate 704 and the liquid-crystal layer of the lens units 71. The third polarizer 30 is configured to filter out polarization components that are not aligned with its transmission axis, such that only linearly polarized light having a polarization direction aligned with the transmission axis is allowed to pass. By ensuring that light entering the liquid-crystal lens has a uniform polarization direction, the polarization quality can be further improved.

As shown in FIG. 7B, commercially available half-wave plates are typically optimized to provide ideal phase retardation at approximately 540 nm (the green-light wavelength band). However, for red-light and blue-light wavelength bands, the phase retardation may deviate from the ideal value of 180 degrees (π radians), causing the transmitted light to deviate from a linear polarization state and become elliptically polarized. By introducing the third polarizer 30, elliptically polarized or circularly polarized components can be filtered out, allowing only linearly polarized light aligned with the transmission axis to pass. Accordingly, even when the incident light is circularly polarized or elliptically polarized, the light ultimately entering the liquid-crystal lens can still be maintained in a linearly polarized state.

In one embodiment, when a fast axis of a half-wave plate forms an angle θ with respect to a polarization direction of incident light, the half-wave plate rotates the polarization direction of the incident light by 2θ. It should be understood that the half-wave plate (λ/2 plate) employed in the present invention is used to rotate the polarization direction of linearly polarized light without changing the type of polarization state. For example, when linearly polarized light is incident at an angle of 45° relative to an optical axis of the half-wave plate, the polarization direction of the light is rotated by twice the incident angle.

By contrast, a quarter-wave plate (λ/4 plate) introduces a phase difference of 90° (π/2 radians) between two orthogonal polarization components, thereby converting linearly polarized light into circularly polarized light, or converting circularly polarized light into linearly polarized light. For example, when linearly polarized light is incident at an angle of 45° relative to an optical axis of a λ/4 plate, the output light becomes circularly polarized. Conversely, when circularly polarized light passes through a λ/4 plate having an appropriately oriented optical axis, it may be converted back into linearly polarized light. In another embodiment, a λ/4 plate may also be used to adjust polarization states so as to improve light transmission efficiency and reduce crosstalk in stereoscopic or multi-view display processes. In comparison, the half-wave plate (λ/2 plate) is primarily used to rotate the polarization direction. Although both the half-wave plate and the quarter-wave plate are birefringent optical elements, their functions and roles within an optical system are different.

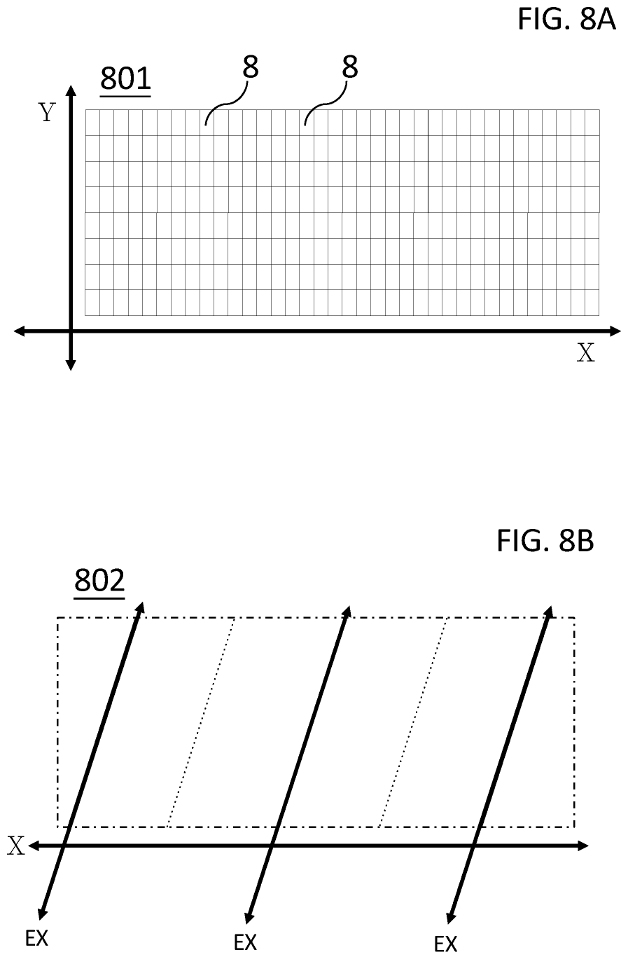

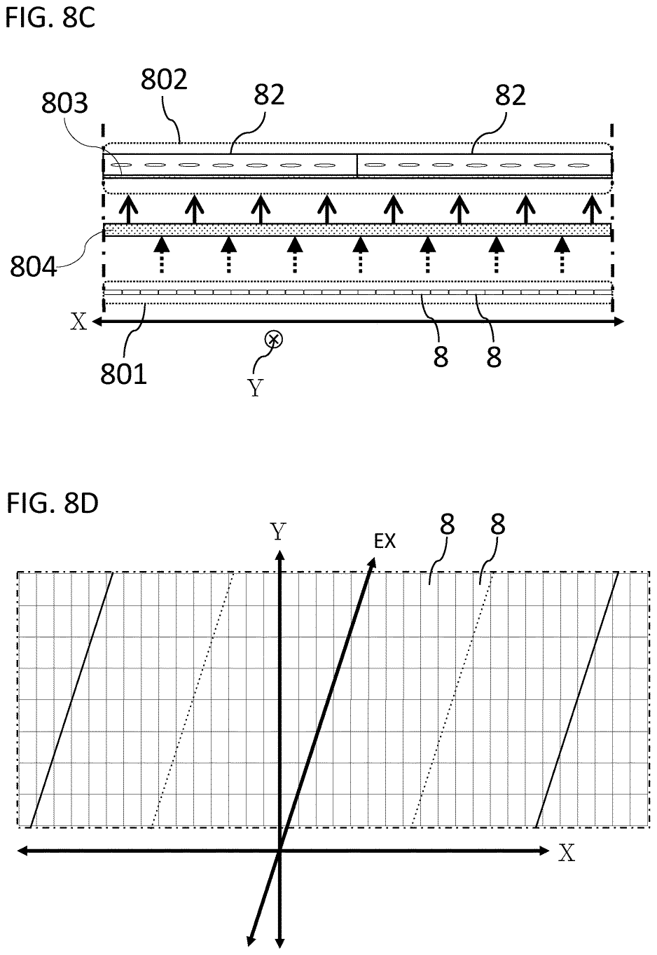

As shown in FIG. 8A, in another embodiment, an autostereoscopic display device may include a pixel array 801 arranged orthogonally for generating display images. The pixel array 801 comprises a plurality of display pixels 8 arranged along a row direction X and a column direction Y. For clarity of illustration, only a limited number of display pixels are shown in the drawings; however, in practical implementations, the display panel typically includes thousands of rows and thousands of columns of display pixels 8.

As shown in FIG. 8B, the autostereoscopic display device may further include an imaging arrangement configured to direct light emitted from different display pixels 8 toward different spatial locations, thereby enabling an observer to perceive stereoscopic three-dimensional images.

For example, as illustrated in FIGS. 8C and 8D, a liquid-crystal lens structure 802 may be disposed above the pixel array 801. The liquid-crystal lens structure 802 includes a plurality of elongated lens units 82 extending substantially parallel to one another and overlying the pixel array 801. Each elongated lens unit 82 extends along a lens direction EX that crosses the row direction X. The lens direction EX defines a geometric extension direction of the elongated lens units, while an effective optical axis of the liquid-crystal lens structure is determined by a liquid-crystal molecular alignment direction under an applied electric field, as described in the foregoing embodiments.

The imaging arrangement includes an electrically controllable lens device implemented in the form of an electrically adjustable lens array. The lens array may include a liquid-crystal material layer (liquid-crystal layer) sandwiched between electrode layers formed on first and second glass substrates disposed opposite to each other. Each electrode layer includes a transparent electrode structure, such as one formed of indium tin oxide (ITO). Each glass substrate is provided with an alignment layer that has been subjected to a mechanical rubbing process, wherein the alignment direction of the alignment layer on the glass substrate adjacent to the display panel is configured to be consistent with a polarization direction of light emitted from the display panel.

By designing electric-field regions having different field intensities within the lens units, the alignment states of liquid-crystal molecules in corresponding regions can be precisely controlled, thereby causing the liquid-crystal layer to exhibit a refractive-index distribution similar to that of a lens and thus altering its optical characteristics. By adjusting the electric-field intensity, the spatial distribution of the refractive index can be dynamically modified, thereby enabling focal-length variation and electrically controlled zooming functionality. This structure provides advantages of low cost, ease of control and facilitates selection of different operating modes of the display device.

The electrode patterns in the first electrode layer and the second electrode layer are preferably designed to have different shapes and are arranged in a mutually non-parallel manner, more preferably in a mutually perpendicular configuration. In this way, the electrode layers can define at least two sets of different lens axes, which may be selectively employed according to display orientation or viewing-angle requirements.

As shown in FIG. 8C, the autostereoscopic display device may further include a third alignment layer 803 disposed within the liquid-crystal lens structure 802. The third alignment layer 803 is subjected to a mechanical rubbing process to form a predetermined alignment direction, wherein the alignment direction is rubbed so as to be substantially perpendicular to the lens direction EX of the elongated lens units described above. Through such an alignment configuration, liquid-crystal molecules within the liquid-crystal lens structure 802 are caused to assume a stable and substantially uniform orientation, either in the absence of an externally applied electric field or under an operating electric field, thereby providing a foundational condition for establishing a desired refractive-index distribution and an effective optical axis of the liquid-crystal lens.

The display device may further include a half-wave plate 804 disposed between the pixel array 801 and the third alignment layer 803. The half-wave plate 804 is configured to rotate a polarization direction of transmitted light such that the rotated polarization direction is aligned with the aforementioned alignment direction. In addition, a polarizer 30 may be disposed between the half-wave plate 804 and the third alignment layer 803 (as illustrated in FIG. 6), so as to further define and stabilize the polarization state of light entering the liquid-crystal lens structure.

Accordingly, based on the foregoing structure, an autostereoscopic display device according to the present embodiment may include: a pixel array 801 comprising a plurality of display pixels 8 arranged orthogonally along a row direction X and a column direction Y, and configured to generate display images; a liquid-crystal lens structure 802 disposed above the pixel array 801, the liquid-crystal lens structure 802 including a plurality of elongated lens units 82 extending substantially parallel to one another, each elongated lens unit 82 having a lens direction EX extending across the row direction X; the liquid-crystal lens structure 802 further including a liquid-crystal layer disposed between a first electrode layer and a second electrode layer arranged opposite to each other, wherein application of different electric-field intensities to different electrodes forms an electrically controllable refractive-index distribution within the liquid-crystal layer.

In one embodiment, transparent electrode patterns of the first electrode layer and the second electrode layer are arranged in a mutually non-parallel manner, for example in a substantially perpendicular configuration, thereby forming electric-field gradients oriented in different directions within the liquid-crystal layer. By selectively applying different driving schemes to the electrode layers, liquid-crystal molecules may be induced to form principal alignment orientations along different directions, such that the liquid-crystal lens structure defines at least two different effective lens axes. These effective lens axes may be selectively utilized to accommodate different display orientations or viewing-direction requirements, for example portrait-mode or landscape-mode viewing.

As used herein, the term “effective lens axis” refers to an equivalent optical principal axis of the liquid-crystal lens formed under an applied driving electric field, which is jointly determined by a principal alignment direction of liquid-crystal molecules and a principal direction of the refractive-index gradient within the liquid-crystal layer, rather than merely a geometric extension direction of the lens units.

The display device may further include: a third alignment layer 803 disposed within the liquid-crystal lens structure 802, the third alignment layer 803 having an alignment direction R formed by a rubbing process and arranged to be substantially perpendicular to the lens direction EX; a half-wave plate 804 disposed between the pixel array 801 and the third alignment layer 803, the half-wave plate 804 being configured to rotate a polarization direction of transmitted light such that the rotated polarization direction is substantially aligned with the alignment direction R; and a polarizer 30 disposed between the half-wave plate 804 and the third alignment layer 803, configured to further define and purify a polarization state of light entering the liquid-crystal lens structure.

As used in this specification, the term “lens axis” or “effective optical axis” refers to an equivalent principal optical axis direction of a liquid-crystal lens when a driving electric field is applied, which is jointly determined by a primary orientation direction of liquid-crystal molecules and a principal direction of a refractive-index gradient formed within the liquid-crystal layer. Unless otherwise specified, the terms “lens axis” and “effective optical axis” are used interchangeably herein and have the same technical meaning.

In other words, when a liquid-crystal layer of a liquid-crystal lens is subjected to an electric-field configuration applied by a first electrode layer and a second electrode layer, such that a lens effect having a graded-index (GRIN) characteristic is formed within the liquid-crystal layer, a dominant optical direction associated with the lens effect is defined as the lens axis or the effective optical axis.

More specifically, for an elongated liquid-crystal lens unit, the lens axis generally corresponds to a primary alignment direction of liquid-crystal molecules, for example, an alignment direction defined by a third alignment layer. For an electrically controlled liquid-crystal lens implemented using patterned electrodes, the lens axis may alternatively be determined by an extending direction of a transparent electrode pattern or by a direction of an electric-field gradient generated thereby.

When a first electrode pattern and a second electrode pattern are arranged in a non-parallel configuration, such as a mutually perpendicular configuration, at least two different lens-axis directions may be correspondingly formed within the liquid-crystal layer. This enables the liquid-crystal lens to selectively switch between different lens axes so as to accommodate different display orientations or viewing-angle requirements.

Accordingly, the term “lens axis” or “effective optical axis” does not merely describe a geometric arrangement direction of the liquid-crystal lens, but instead denotes a dominant direction of its optical functionality, including, but not limited to, a focusing direction of the lens, a direction along which liquid-crystal molecules are guided to form a refractive-index gradient, and an optical-axis direction with which incident polarized light is required to be aligned during half-wave-plate polarization compensation.

In all embodiments of the present invention, the lens axis is used to define a target direction to which an incident polarization direction is rotated by a half-wave plate so as to achieve optimal optical-axis matching, such that a rotated polarization direction is substantially parallel to an alignment direction of the third alignment layer, thereby enabling the liquid-crystal lens to exhibit optimal optical performance.

In another embodiment, as illustrated in FIGS. 9A and 9B, an electrically controllable liquid crystal lens assembly 900 may include a first substrate 901 and a second substrate 902 disposed opposite to each other, and a liquid crystal layer interposed between the first substrate 901 and the second substrate 902. A first electrode layer may be formed on the first substrate 901 and may have a first transparent electrode pattern including a first electrode group I1 and a second electrode group I2. The first transparent electrode pattern may include a plurality of first electrode finger portions extending in a first direction. A second electrode layer may be formed on the second substrate 902 and may have a second transparent electrode pattern I20. The second transparent electrode pattern I20 may include a plurality of second electrode finger portions extending in a second direction that is non-parallel to the first direction.

The mutually non-parallel arrangement of the first transparent electrode pattern and the second transparent electrode pattern I20 may define, within the liquid crystal layer, at least two different lens-axis directions respectively corresponding to the first direction and the second direction. By applying independently controlled voltages or electric fields to the first electrode layer and the second electrode layer, a spatially varying refractive-index distribution may be generated at different lateral positions within the liquid crystal layer. Accordingly, an electrically controllable graded-index (GRIN) lens may be formed, and a focal length, an optical-axis orientation, or a lateral position of an optical action region of the lens may be electrically adjusted.

In the embodiment, a liquid crystal lens assembly 900 may include: a first substrate and a second substrate disposed opposite to each other; a liquid crystal layer interposed between the first substrate and the second substrate; a first electrode layer formed on the first substrate, the first electrode layer having first transparent electrode patterns corresponding to the first electrode group I1 and the second electrode group I2, wherein the first transparent electrode patterns include a plurality of first electrode finger portions extending along a first direction; and a second electrode layer formed on the second substrate, the second electrode layer having a second transparent electrode pattern I20, wherein the second transparent electrode pattern I20 includes a plurality of second electrode finger portions extending along a second direction that is non-parallel to the first direction.

The non-parallel arrangement between the first transparent electrode patterns corresponding to the first electrode group I1 and the second electrode group I2 and the second transparent electrode pattern I20 defines, within the liquid crystal layer, at least two different lens-axis orientations respectively corresponding to the first direction and the second direction. By independently applying voltages or electric fields to the first electrode layer and the second electrode layer, a spatially varying refractive-index distribution is generated at different lateral positions within the liquid crystal layer, thereby forming an electrically controllable graded-index (GRIN) liquid crystal lens and enabling electrical adjustment of a focal length, a lens-axis orientation, or a lateral position of an optical action region.

The first electrode layer of the liquid crystal lens may include the transparent electrode patterns corresponding to the first electrode group I1 and the second electrode group I2, and the second electrode layer may include the transparent electrode pattern I20. The electrode patterns may be composed of a plurality of electrode finger portions. As used herein, the term “electrode finger portions” refers to elongated electrode segments formed of a transparent conductive material, such as indium tin oxide (ITO), which are typically arranged in an interdigitated or stripe-like configuration. In some embodiments, each electrode finger portion may have a width on the order of several micrometers to several tens of micrometers, and may extend linearly or with a slight curvature along its extension direction, so as to generate an electric-field distribution having a spatial gradient within the liquid crystal layer.

Because the refractive index of liquid crystal material depends on the orientation state of liquid crystal molecules under a local electric field, the shape, width, spacing, and extension direction of the electrode finger portions may be adjusted to control the electric-field distribution in different regions of the liquid crystal layer. For example, when the electrode finger portions of the first electrode layer and those of the second electrode layer are arranged in non-parallel orientations, such as in mutually perpendicular directions, the resulting combined electric-field distribution may exhibit directional variations. As a result, at least two different lens-axis orientations may be selectively formed within the liquid crystal layer, allowing the liquid crystal lens to switch between different lens-axis orientations according to different driving electric-field configurations.

Accordingly, the liquid crystal layer may be modulated to exhibit graded-index (GRIN) optical characteristics and to form a liquid crystal lens having an electrically controllable focal length or an electrically controllable lens-axis orientation. By independently applying different voltage combinations to the first electrode layer and the second electrode layer, different local electric-field distributions may be generated within the liquid crystal layer, causing liquid crystal molecules at different positions to undergo different degrees of reorientation and thereby altering the refractive-index distribution. In this manner, electrical adjustment of a focal length, an imaging direction, a lens-axis orientation, or a lateral position of an optical action region of the liquid crystal lens can be achieved.

The electrode finger portion structures described herein enable highly controllable optical behavior of the liquid crystal lens without significantly increasing fabrication complexity, and are particularly suitable for autostereoscopic display applications or multi-view display applications.

In another embodiment, as shown in FIG. 8C, a liquid-crystal lens structure 802 may include a plurality of elongated lens units 82 extending parallel to one another along a lens direction; a liquid-crystal layer corresponding to the elongated lens units; and a third alignment layer 803 disposed adjacent to the liquid-crystal layer. The third alignment layer 803 is subjected to a rubbing process to form an alignment direction that is substantially perpendicular to the lens direction. Accordingly, liquid-crystal molecules within the liquid-crystal layer are guided by the perpendicular alignment direction to obtain a uniform and consistent molecular arrangement, thereby stabilizing optical performance corresponding to the lens direction.

In the embodiment, as shown in FIG. 8C, an optical compensation structure for a liquid-crystal lens may include a liquid-crystal lens having an optical axis associated with a liquid-crystal alignment direction; and a half-wave plate 804 disposed in an optical path prior to the liquid-crystal lens. The half-wave plate 804 has a fast axis forming an angle θ relative to a polarization direction of incident linearly polarized light. By virtue of the fast axis, the half-wave plate rotates the polarization direction of the incident light by 2θ, such that the rotated polarization direction becomes substantially parallel to the optical axis of the liquid-crystal lens. The angle θ is selected such that the fast-axis orientation of the half-wave plate corresponds approximately to one half of an angular difference between a transmission axis of a preceding polarizer and the optical axis of the liquid-crystal lens, thereby compensating for optical-axis misalignment between the polarizer and the liquid-crystal lens.

As used herein, the term “fast axis” refers to a principal axis of a birefringent optical element along which light experiences a lower refractive index and thus propagates at a higher velocity. A half-wave plate utilizes the refractive-index difference between the fast axis and a slow axis to introduce a half-wave phase retardation between orthogonally polarized components of light, thereby rotating the polarization direction of linearly polarized light.

In order to improve the polarization quality of light prior to entering the liquid-crystal lens layer, the present invention provides the third polarizer disposed downstream of the half-wave plate and upstream of the liquid-crystal lens layer. As used herein, the terms “upstream” and “downstream” are technical terms describing positions along an optical path, wherein “upstream” refers to a position before light passes through a particular optical component, and “downstream” refers to a position after light has passed through that component. Accordingly, in this embodiment, the half-wave plate is located upstream in the optical path, while the third polarizer is disposed downstream of the half-wave plate and upstream of the liquid-crystal lens layer.

The half-wave plate is primarily configured to rotate the polarization direction of incident linearly polarized light. However, because the phase retardation of commercially available half-wave plates is wavelength-dependent, at wavelengths other than the design center wavelength (typically approximately 540 nm), the transmitted light may acquire elliptically polarized or circularly polarized components, such that the polarization state is no longer purely linear. To compensate for this effect, the present invention employs the third polarizer disposed downstream of the half-wave plate. The third polarizer has a transmission axis configured to allow passage only of linear-polarization components aligned with the transmission axis, while blocking polarization components that deviate from the transmission axis and fail to maintain a linear polarization state, such as elliptically polarized or circularly polarized components resulting from phase-retardation errors of the half-wave plate.

By virtue of this polarization-purification mechanism, even if polarization ellipticity is introduced by the half-wave plate at different wavelengths, such undesired polarization components can be effectively filtered out by the third polarizer. As a result, the transmitted light maintains a consistent and high-purity linear polarization state, with the polarization direction accurately aligned with the alignment direction defined by the alignment layer within the liquid-crystal lens layer. This configuration significantly enhances the optical stability of the liquid-crystal lens, improves light-transmission efficiency, increases contrast and image clarity in stereoscopic display applications, and reduces multi-view crosstalk caused by polarization mismatch.

Accordingly, as shown in FIG. 7A, in the embodiment, a polarization-purification module for a liquid-crystal lens system may include: a half-wave plate 704 configured to rotate a polarization direction of incident linearly polarized light; and a third polarizer 30 disposed downstream of the half-wave plate and upstream of a liquid-crystal lens layer, the third polarizer having a transmission axis; wherein the third polarizer allows only a linear-polarization component aligned with the transmission axis to pass therethrough; wherein elliptical-polarization or circular-polarization components generated due to wavelength-dependent phase-retardation variations of the half-wave plate 704 are blocked by the third polarizer 30; and wherein only a purified linear-polarization component aligned with the transmission axis is incident upon the liquid-crystal lens layer.

In another embodiment, as shown in FIGS. 10A and 10B, a stereoscopic image display system may include a display device 100 configured to display image content, a liquid-crystal lens disposed between the display device 100 and a stereoscopic viewing position 10, and a control circuit coupled to the display device 100 and the liquid-crystal lens. The display device 100 may display left-eye image information and right-eye image information in an interleaved format. For example, at a given time, display pixels or image components of the display device 100 may define a left-eye image field including left-eye image segments l1 and l2 and a right-eye image field including right-eye image segments r1 and r2, the left-eye image field and the right-eye image field being interleaved with each other.

The liquid-crystal lens may include a plurality of potential-applying electrodes 200, 201 configured to receive electric potentials for controlling an effective optical position or an optical action region of the liquid-crystal lens. The control circuit may control which display pixels or image components define the left-eye image field and the right-eye image field, and may control electric potentials applied to the potential-applying electrodes 200, 201 so as to laterally shift the effective optical position or the optical action region of the liquid-crystal lens. In this manner, the right-eye image field may be directed toward a right eye of a viewer, and the left-eye image field may be directed toward a left eye of the viewer.

In some embodiments, at different points in time, the control circuit may cause image components of the left-eye image field and adjacent image components of the right-eye image field to be interchanged. During such interchange of the image components, the control circuit may synchronously change the electric potentials applied to the potential-applying electrodes 200, 201, thereby laterally shifting the effective optical position or the optical action region of the liquid-crystal lens. Accordingly, both before and after the interchange of the image components, the interleaved left-eye image field and right-eye image field may remain optically directed toward the corresponding left eye and right eye of the viewer.

As described above, a method of alternately reassigning image segments, such as different image fields of image content, to different viewing zones over multiple time intervals may be applied in conjunction with a liquid crystal (LC) lens to improve effective resolution in a 3D display mode. In general, in an autostereoscopic 3D mode, because left-eye images and right-eye images are displayed for corresponding eyes, the effective per-eye display resolution may be reduced relative to a two-dimensional display mode. By rapidly and alternately reassigning the image segments to different viewing zones, such effective resolution loss may be reduced. For example, as illustrated in FIG. 9A, in the first frame, rendered content may be assigned to viewing zones G1, G2, . . . corresponding respectively to right-eye images and left-eye images. If, in a subsequent frame, the right-eye images and left-eye images are reassigned to opposite viewing zones G2, G1, . . . , and the first frames and subsequent frame are continuously and rapidly alternated, the amount of spatial image information delivered to each eye over time may be increased, thereby improving perceived effective resolution.

As illustrated in FIGS. 9A and 9B, a basic structure of a liquid crystal lens assembly 900 may include an upper transparent substrate 901, a lower transparent substrate 902, an electrode set I1, and an electrode set I2. When the electrode sets I1 and I2 are switched, the left-eye image display and the right-eye image display may be synchronously switched, thereby reducing effective resolution loss in the 3D display mode.

Accordingly, a stereoscopic image display system may include a display device and a control circuit. The display device may include a liquid crystal lens element configured to laterally shift an optical action region, for example via at least two electrode sets I1 and I2, for providing left-eye images and right-eye images to a viewer located at a stereoscopic viewing position in the form of interleaved image components. At any given time, the interleaved image components may define a left-eye image field, such as l1 and l2, interlaced with a right-eye image field, such as r1 and r2. The control circuit may be coupled to the display device and may be configured to control which image components define the image fields and to control the liquid crystal lens element such that the viewer's left eye views the left-eye image field and the viewer's right eye views the right-eye image field.

The control circuit may be coupled to the display device and may be configured to, at different points in time, interchange the display of the left-eye image field and the right-eye image field. For example, frames 1, 3, 5, . . . may display one pixel assignment, and frames 2, 4, 6, . . . may display another pixel assignment. During the image-field interchange, the control circuit may change an effective electric-field distribution or a position of an optical action region of the liquid-crystal lens element, for example by switching between electrode sets I1 and I2 while simultaneously switching the left-eye image display and the right-eye image display. In this manner, both before and after the interchange, the viewer may continuously perceive the corresponding stereoscopic image fields through the respective left eye and right eye.

According to another aspect of the present disclosure, a stereoscopic image display system may include a display device, a liquid-crystal lens element, and a control circuit. The display device may be configured to display images. The liquid-crystal lens element may be disposed in front of the display device and may include at least a first set of electrodes, such as electrode set I1, and a second set of electrodes, such as electrode set I2. The first and second sets of electrodes may be configured to change an effective electric-field distribution within the liquid crystal lens element, thereby laterally shifting an optical action region of the liquid-crystal lens element. The display device may display interleaved image components that define, at a given time, a left-eye image field and a right-eye image field respectively viewable by a left eye and a right eye of a viewer.

The control circuit may be coupled to the display device and the liquid-crystal lens element. The control circuit may be configured to control the display device to generate a left-eye image and a right-eye image, and to divide the left-eye image and the right-eye image into a plurality of image segments that are alternately reassigned to different viewing regions over multiple time periods. The control circuit may further control switching of the first set of electrodes and the second set of electrodes of the liquid-crystal lens element such that the left-eye image field and the right-eye image field are interchanged in correspondence with reassignment of the image segments. During interchange of the image fields, the control circuit may synchronously adjust the effective electric-field distribution or the optical action region of the liquid-crystal lens element, such that the viewer is able to continuously perceive corresponding stereoscopic image fields with the left eye and the right eye both before and after the interchange. Accordingly, effective resolution loss typically associated with stereoscopic display operation may be reduced.

In contrast to the stereoscopic image display system disclosed in European Patent No. EP0713630B1, which achieves left-eye and right-eye image separation by using variable-transparency shutter elements, embodiments of the present disclosure utilize electrical potential control of a liquid crystal (LC) lens to laterally shift an effective optical position or an optical action region of the lens, thereby optically directing image light toward a corresponding viewing eye of an observer. This configuration differs from the system disclosed in EP0713630B1 in terms of optical principle and control methodology. In particular, EP0713630B1 does not disclose synchronously controlling interchange of image fields together with lateral optical displacement of a liquid-crystal lens. In some embodiments of the present disclosure, image-field reassignment is coordinated with electrically induced displacement of an optical action region of the liquid-crystal lens.

For example, the technical features of EP0713630B1 are primarily directed to image-domain processing, in which left-eye and right-eye images are displayed in the form of interlaced image fields, and stereoscopic presentation is achieved by controlling which image components belong to the left-eye image field or the right-eye image field, with periodic interchange thereof. The optical separation mechanism employed in EP0713630B1 relies on a shutter system including variable-transparency shutter elements. The control strategy involves synchronously switching transparency states of the shutter elements during image-field interchange, so as to attenuate image components intended for a non-corresponding eye. Such a system is therefore attenuation-based, in that stereoscopic separation is achieved by selectively blocking undesired light rather than by laterally displacing an optical action region of a liquid crystal lens to redirect image light.

In some embodiments, as shown in FIG. 10E, the first electrode group I1 and the second electrode group I2 may be arranged in an asymmetric lateral configuration, particularly in an edge region of the liquid crystal lens. For example, a first lateral distance d1 between adjacent electrodes may be different from a second lateral distance d2 between adjacent electrodes. By arranging the first electrode group I1 and the second electrode group I2 with such asymmetric lateral distances, an effective electric-field distribution may be more completely formed near the edge region of the liquid crystal lens.

In some comparative configurations, when electrodes are arranged in a symmetric or uniformly spaced manner, a portion of an intended lens region near an edge of the liquid crystal lens may lack a corresponding electrode or may receive an insufficient electric field. Such a region may form an incomplete electric-field formation region, in which a desired refractive-index gradient or optical action region is not fully established. In contrast, the asymmetric arrangement shown in FIG. 10E may reduce an area of the incomplete electric-field formation region at the edge region.

Accordingly, the asymmetric lateral configuration of the first electrode group I1 and the second electrode group I2 may improve formation of the refractive-index distribution near the edge region, reduce optical mismatch between a pixel assignment and a lens state, reduce crosstalk or luminance non-uniformity near the edge region, and improve stereoscopic image quality.

Although the present embodiment may also involve image-field interchange, it differs from the system disclosed in EP0713630B1 in optical implementation mechanisms and control hierarchy. In some embodiments, the present disclosure introduces a liquid-crystal (LC) lens system in which electrical potentials applied to the LC lens are used to control an effective optical position or an optical action region thereof. Instead of employing attenuation-based light blocking, the LC lens system utilizes lateral displacement of the effective optical position or the optical action region to guide image light, such that the left eye and the right eye respectively receive corresponding image fields after reassignment.

In particular, laterally shifting an effective optical position or an optical action region by controlling at least two electrode sets differs from transparency switching. In some embodiments, different voltage configurations applied to multiple electrode sets induce a lateral displacement of an effective refractive-index distribution within the liquid-crystal lens. By contrast, EP0713630B1 controls transparent or opaque states of shutter elements. For example, EP0713630B1 relies on an attenuation mechanism to prevent an incorrect eye from receiving image content, wherein the shutter elements affect light intensity without changing a propagation path of light. In the present disclosure, however, the lateral optical displacement produced by the LC lens modifies propagation paths of image light. Thus, whereas the shutter-based system blocks undesired light, embodiments of the present disclosure guide image light toward a corresponding spatial position.

Although both approaches may involve synchronous control during image-field interchange, the synchronous control in EP0713630B1 involves switching transparency states of shutter elements during image-field interchange, and therefore is based on attenuation of light intensity. In contrast, in embodiments of the present disclosure, synchronous control may involve controlling lateral displacement of an effective optical position or an optical action region of a liquid crystal lens while interchanging image fields and updating corresponding image content. This process may involve voltage configurations applied to electrode groups, dynamic modulation of refractive-index distributions within the LC lens, and coordinated updating of displayed image fields. At the same time, such control may improve light-use efficiency, reduce attenuation loss, and reduce effective resolution degradation that may occur in stereoscopic display operation.

EP0713630B1 does not disclose switching applied electrical potentials to produce a lateral optical displacement in a LC lens, nor does it disclose synchronously controlling image-field interchange in correspondence with such lateral optical displacement. In embodiments of the present disclosure, a LC lens system having multiple electrode groups or potential-applying electrodes is used to provide a lateral optical displacement mechanism instead of an attenuation-based shutter mechanism.

Furthermore, as illustrated in FIGS. 10A and 10B, in the first frame, right-eye image content r1 and left-eye image content l1 may be displayed according to the first pixel assignment A1. In the subsequent frame, left-eye image content l2 and right-eye image content r2 may be displayed according to a second pixel assignment A2 at reassigned pixel positions. Accordingly, as shown in FIG. 10C, the viewer's visual system may integrate the image contents over time to perceive combined right-eye and left-eye image fields. In other words, the image contents may include at least four distinct sets of content, such as r1, l1, l2, and r2, that define at least one left-eye image field and at least one right-eye image field arranged in an interlaced manner. This implementation differs from a display approach in which only two sets of content, such as one left-eye image and one right-eye image, are prepared.

As illustrated in FIGS. 10D and 10E, the relative positions of the first set of electrodes, such as I1, and the second set of electrodes, such as I2, may be adjusted to increase the range of achievable display effects or optical routing states. As illustrated in FIGS. 10F, 10G, and 10H, the shapes of the first set of electrodes and the second set of electrodes may also be modified to generate different electric-field distributions, thereby further expanding the available display-effect variations. In addition, as illustrated in FIGS. 10F, 10G, and 10H, a third set of electrodes, such as I3, may be provided and used during other frame sets or other temporal intervals to further increase the diversity of display effects or optical routing configurations.

Accordingly, by using LC lens element instead of an attenuation-based shutter system and by providing at least two sets of electrodes such that an effective optical position or an optical action region of the LC lens undergoes lateral displacement, the display system may increase the variety and flexibility of achievable display effects. The foregoing structures and configurations may enhance brightness, contrast, or viewing angle, while increasing the range of display-effect variations that can be provided. As a result, the autostereoscopic display device of the present disclosure may be suitable for a wide variety of application scenarios, including but not limited to gaming, medical imaging, and virtual-reality applications.

In some embodiments, an autostereoscopic display apparatus includes a display device, a liquid crystal (LC) lens, and a control circuit. The display device is configured to display image content including a left-eye image and a right-eye image. The display device may include a plurality of display pixels arranged in rows and columns. In some embodiments, the display device may be implemented as an LCD panel, an OLED panel, a micro-LED panel, or another suitable display panel. Each display pixel may correspond to a pixel, a sub-pixel, or a group of pixels or sub-pixels, depending on a pixel layout and a rendering method used by the display device.

The LC lens is disposed on one side of the display device, for example along a light-emitting direction of the display device. The LC lens includes a liquid crystal layer, a first electrode group, and a second electrode group. The second electrode group may be laterally offset from the first electrode group. For example, at least some electrodes of the second electrode group may be located at lateral positions different from corresponding electrodes of the first electrode group. The first electrode group and the second electrode group may be formed of a transparent conductive material, such as indium tin oxide (ITO), or another suitable conductive material.

By driving the first electrode group and the second electrode group under different driving conditions, the LC lens may form different effective electric-field distributions in the liquid crystal layer. The different effective electric-field distributions may cause liquid crystal molecules in the liquid crystal layer to assume different orientation distributions, thereby forming different refractive-index distributions. As a result, an optical action region of the LC lens may be laterally displaced. The optical action region may correspond to an effective lens center, a refractive-index-gradient region, a light-steering region, or another region of the LC lens that optically directs light emitted from the display pixels toward one or more viewing zones.

The control circuit is coupled to the display device and the LC lens. The control circuit may operate the autostereoscopic display apparatus in at least a first operating state and a second operating state alternating with the first operating state. In some embodiments, the first operating state and the second operating state may correspond to different display frames, groups of frames, sub-frame intervals, refresh periods, or other temporal intervals. For example, the first operating state may be performed during odd-numbered frames, and the second operating state may be performed during even-numbered frames. In other embodiments, the first operating state and the second operating state may be performed according to another predetermined or adaptive temporal sequence.

In the first operating state, the control circuit controls the display device to display a first segment and a first subsequent segment according to a first pixel assignment. The first segment and the first subsequent segment may be portions of the image content displayed during the first operating state. In some embodiments, the first segment may include left-eye image information, and the first subsequent segment may include right-eye image information. The first segment and the first subsequent segment may be displayed in an interleaved arrangement by the plurality of display pixels. For example, a first set of display pixels or pixel positions may display the first segment, and a second set of display pixels or pixel positions may display the first subsequent segment. The first set and the second set may be arranged alternately, periodically, or otherwise interleaved across the display device.

During the first operating state, the control circuit also drives the first electrode group so that the LC lens operates in a first lens state. In the first lens state, the optical action region of the LC lens is positioned to direct light from the first segment toward a left eye of a viewer and to direct light from the first subsequent segment toward a right eye of the viewer. Accordingly, in the first operating state, the viewer's left eye receives image information corresponding to the first segment, and the viewer's right eye receives image information corresponding to the first subsequent segment.

In the second operating state, the control circuit controls the display device to display a second segment and a second subsequent segment according to a second pixel assignment. The second segment and the second subsequent segment may be portions of the image content displayed during the second operating state. In some embodiments, the second segment may include left-eye image information different from, subsequent to, or complementary to the left-eye image information of the first segment, and the second subsequent segment may include right-eye image information different from, subsequent to, or complementary to the right-eye image information of the first subsequent segment. The second segment and the second subsequent segment may also be displayed in an interleaved arrangement by the plurality of display pixels.

The second pixel assignment uses pixel positions laterally different from pixel positions used in the first pixel assignment. For example, a pixel position used to display the first segment in the first operating state may be different from a pixel position used to display the second segment in the second operating state. Similarly, a pixel position used to display the first subsequent segment in the first operating state may be different from a pixel position used to display the second subsequent segment in the second operating state. In some embodiments, a pixel or pixel group that displays image information directed toward the right eye in the first operating state may display image information directed toward the left eye in the second operating state, and another pixel or pixel group that displays image information directed toward the left eye in the first operating state may display image information directed toward the right eye in the second operating state.

During the second operating state, the control circuit drives the second electrode group so that the LC lens operates in a second lens state. Since the second electrode group is laterally offset from the first electrode group, driving the second electrode group may produce an effective electric-field distribution different from that produced by driving the first electrode group. The second lens state may therefore laterally displace the optical action region of the LC lens relative to the first lens state. In the second lens state, the laterally displaced optical action region directs light from the second segment toward the left eye of the viewer and directs light from the second subsequent segment toward the right eye of the viewer, even though the second segment and the second subsequent segment are displayed at pixel positions different from those used in the first pixel assignment.

In some embodiments, the amount by which the optical action region is laterally displaced in the second lens state corresponds to a positional difference between the first pixel assignment and the second pixel assignment. The positional difference may refer to a lateral offset between pixel positions used in the first pixel assignment and corresponding pixel positions used in the second pixel assignment. For example, the positional difference may include a lateral offset between a pixel position used to display image information directed toward the left eye in the first operating state and a pixel position used to display corresponding image information directed toward the left eye in the second operating state. The positional difference may also include a lateral offset between a pixel position used to display image information directed toward the right eye in the first operating state and a pixel position used to display corresponding image information directed toward the right eye in the second operating state.

The amount of lateral displacement of the optical action region need not be physically equal to a physical pixel pitch or to a physical distance between two adjacent display pixels. In various embodiments, the amount may correspond to a full pixel pitch, a sub-pixel pitch, a fraction of a pixel pitch, a pixel-group pitch, or an optically equivalent lateral displacement. The amount may be determined according to one or more parameters, such as a pixel pitch of the display device, a lateral offset between the first electrode group and the second electrode group, an electrode pitch, a cell gap of the liquid crystal layer, a refractive-index distribution generated in the liquid crystal layer, a viewing distance, or a target viewing zone. In some embodiments, the amount may be determined by design, calibration, a lookup table, or real-time control performed by the control circuit.

By alternately performing the first operating state and the second operating state, the control circuit causes the left eye of the viewer to receive left-eye image information from different display pixels in different periods. Similarly, the control circuit causes the right eye of the viewer to receive right-eye image information from different display pixels in different periods. Because the first lens state and the second lens state are coordinated with the first pixel assignment and the second pixel assignment, respectively, the LC lens maintains optical separation between the left-eye image and the right-eye image while different display pixels are used over time.

In this manner, the autostereoscopic display apparatus may increase an amount of spatial image information delivered to each eye over multiple periods, while maintaining proper optical routing of the left-eye image information and the right-eye image information to the corresponding eyes of the viewer. Accordingly, effective per-eye resolution loss that may occur in an autostereoscopic display mode may be reduced, and perceived stereoscopic image quality may be improved.

The invention therefore provides a practical and scalable solution for improving image fidelity and enhancing user experience in autostereoscopic display technologies. All modifications and variations of the present invention that fall within the scope defined by the appended claims are intended to be encompassed within the protection of the present invention. Although specific embodiments have been described herein, one of ordinary skill in the art will recognize that various modifications, substitutions, and alternative implementations may be employed without departing from the scope of the present disclosure. Accordingly, the disclosed embodiments should be considered illustrative rather than limiting, and the scope of protection should be determined according to the appended claims and equivalents thereof.

1. An autostereoscopic display system, comprising:
a display device configured to display image content including a left-eye image and a right-eye image, the display device including a plurality of display pixels;
a liquid crystal lens disposed on one side of the display device, the liquid crystal lens including a liquid crystal layer, a first electrode group, and a second electrode group, the first electrode group and the second electrode group being laterally offset from each other, and the liquid crystal lens being configured to change an effective electric-field distribution in the liquid crystal layer by switching between driving states of the first electrode group and the second electrode group, thereby causing an optical action region of the liquid crystal lens to be laterally displaced; and
a control circuit coupled to the display device and the liquid crystal lens, the control circuit being configured to:
control the display device to generate the left-eye image and the right-eye image, provide at least a first left-eye image segment and a second left-eye image segment from the left-eye image, and provide at least a first right-eye image segment and a second right-eye image segment from the right-eye image;
during a plurality of first periods, control the display device to display the first left-eye image segment and the first right-eye image segment according to a first pixel assignment, such that the first left-eye image segment and the first right-eye image segment are displayed in an interleaved arrangement by the plurality of display pixels, and drive the first electrode group to operate the liquid crystal lens in a first lens state, such that the first left-eye image segment is directed toward a left eye of a viewer and the first right-eye image segment is directed toward a right eye of the viewer; and
during a plurality of second periods alternating with the plurality of first periods, control the display device to display the second left-eye image segment and the second right-eye image segment according to a second pixel assignment, such that the second left-eye image segment and the second right-eye image segment are displayed in an interleaved arrangement by the plurality of display pixels and are displayed at different pixel positions in a lateral direction relative to the first pixel assignment, and drive the second electrode group to operate the liquid crystal lens in a second lens state, such that the second left-eye image segment is directed toward the left eye of the viewer and the second right-eye image segment is directed toward the right eye of the viewer;
wherein the second lens state laterally displaces the optical action region of the liquid crystal lens, relative to the first lens state, by an amount corresponding to a positional difference between the first pixel assignment and the second pixel assignment; and
wherein, by alternately performing the first pixel assignment and the second pixel assignment, the control circuit causes the left eye of the viewer to view the first left-eye image segment and the second left-eye image segment in different periods, and causes the right eye of the viewer to view the first right-eye image segment and the second right-eye image segment in different periods.

2. An autostereoscopic display apparatus, comprising:
a display device configured to display image content including a left-eye image and a right-eye image, the display device including a plurality of display pixels;
a LC lens disposed on one side of the display device, the LC lens including a liquid crystal layer, a first electrode group, and a second electrode group laterally offset from the first electrode group, the LC lens being configured to form different effective electric-field distributions in the liquid crystal layer in response to driving of the first electrode group and the second electrode group, thereby laterally displacing an optical action region of the LC lens; and
a control circuit coupled to the display device and the LC lens, the control circuit being configured to operate the autostereoscopic display apparatus in at least a first operating state and a second operating state alternating with the first operating state,
wherein, in the first operating state, the display device displays a first segment and a first subsequent segment according to a first pixel assignment in an interleaved arrangement by the plurality of display pixels, and the LC lens is operated in a first lens state by driving the first electrode group, such that the first segment is directed toward a left eye of a viewer and the first subsequent segment is directed toward a right eye of the viewer,
wherein, in the second operating state, the display device displays a second segment and a second subsequent segment according to a second pixel assignment in an interleaved arrangement by the plurality of display pixels, the second pixel assignment using pixel positions laterally different from pixel positions used in the first pixel assignment, and the LC lens is operated in a second lens state by driving the second electrode group, such that the second segment is directed toward the left eye of the viewer and the second subsequent segment is directed toward the right eye of the viewer, wherein the second lens state laterally displaces the optical action region of the LC lens, relative to the first lens state, by an amount corresponding to a positional difference between the first pixel assignment and the second pixel assignment, and
wherein the first operating state and the second operating state are alternately performed so that the left eye of the viewer receives left-eye image information from different display pixels in different periods and the right eye of the viewer receives right-eye image information from different display pixels in different periods.

3. The autostereoscopic display apparatus of claim 2, wherein the first segment includes left-eye image information and the first subsequent segment includes right-eye image information, and wherein the second segment includes left-eye image information and the second subsequent segment includes right-eye image information.
